(19) United States
(12) Patent Application Publication
(10) Pub. No.: US 2026/0111765 A1
(43) Pub. Date: Apr. 23, 2026

(54) AUTONOMOUS DATA RESOLUTION WITH LOGICAL REPRESENTATION OF WORKFLOWS

(71) Applicant: Dell Products L.P., Round Rock, TX (US)

(72) Inventors: Thirumaleshwara Adyanadka Shama, Austin, TX (US); Shibi Panikkar, Bangalore (IN)

(21) Appl. No.: 18/920,492

(22) Filed: Oct. 18, 2024

(51) Int. Cl. G06N 5/04

(52) U.S. Cl. CPC G06N 5/04

(57) ABSTRACT

Autonomous data resolution with logical representation of workflows can be performed and enhanced. DRPM analyzes received electronic document. If analysis indicates information item, of group of information items, in document does not match entities of document schema(s), trained model can perform AI-based analysis on document. Based on AI-based analysis results, trained model can infer information item is representative of an entity. Trained model can receive feedback information indicating inference is correct. Based on feedback information, trained model can be updated to recognize the information item can be representative of the entity. Logical model can determine service type associated with document. Based on service type, DED can determine workflows to perform, interfaces to call, and sequence of calling interfaces. Data enricher calls interfaces to obtain additional information items. Model creator generates service model type based on entities and other information items identified in document and additional information items.

### BACKGROUND

Computer systems can be utilized to generate, process, and communicate electronic documents, including electronic documents associated with applications, word processing documents, message documents, chat documents, and/or other types of electronic documents, and information contained in such electronic documents. The electronic documents, and/or the information contained in the electronic documents, can be in a structured or unstructured format.

The above-described description is merely intended to provide a contextual overview regarding computer and data processing systems, and is not intended to be exhaustive.

### SUMMARY

The following presents a simplified summary in order to provide a basic understanding of some aspects described herein. This summary is not an extensive overview of the disclosed subject matter. It is intended to neither identify key or critical elements of the disclosure nor delineate the scope thereof. Its sole purpose is to present some concepts in a simplified form as a prelude to the more detailed description that is presented later.

In some embodiments, the disclosed subject matter can comprise a method that can comprise performing, using a trained model of a system comprising at least one processor, an artificial intelligence-based analysis on respective items of information of an electronic document, wherein the trained model can be trained based on schema information relating to a group of document schemas relating to a group of application entities associated with an application. The method also can comprise: based on a result of the artificial intelligence-based analysis, inferring, using the trained model of the system, that an item of information, of the respective items of information, can be an application entity of the group of application entities.

In certain embodiments, the disclosed subject matter can comprise a system that can comprise at least one memory that can store computer executable components, and at least one processor that can execute computer executable components stored in the at least one memory. The computer executable components can comprise an entity recognition engine that can receive an electronic document. The computer executable components also can comprise a trained model that can perform an artificial intelligence-based analysis on the electronic document comprising respective items of data, wherein the trained model can be trained based on schema data relating to a group of document schemas relating to a group of named entities associated with an application, and wherein, based on a result of the artificial intelligence-based analysis, the trained model can derive that an item of data, of the respective items of data, can be a named entity of the group of named entities.

In still other embodiments, the disclosed subject matter can comprise a non-transitory machine-readable medium, comprising executable instructions that, when executed by at least one processor, can facilitate performance of operations. The operations can comprise receiving, by network equipment of a core network, a first container, comprising first artificial intelligence-related data, from a first base station, wherein a first artificial intelligence model located in the core network can be trained, based on the first artificial intelligence-related data, to generate a trained global artificial intelligence model. The operations also can comprise communicating a second container, comprising second artificial intelligence-related data, to a second base station to facilitate training or updating a second artificial intelligence model located at the second base station, wherein the second artificial intelligence-related data can be determined based on the trained first artificial intelligence model.

The following description and the annexed drawings set forth in detail certain illustrative aspects of the subject disclosure. These aspects are indicative, however, of but a few of the various ways in which the principles of various disclosed aspects can be employed and the disclosure is intended to include all such aspects and their equivalents. Other advantages and features will become apparent from the following detailed description when considered in conjunction with the drawings.

### BRIEF DESCRIPTION OF THE DRAWINGS

FIG. 1 illustrates a block diagram of a non-limiting example system that can desirably manage and perform data resolution and data processing with logical representation of workflows to facilitate processing of requests for services, subscriptions, or products, in accordance with various aspects and embodiments of the disclosed subject matter.

FIG. 2 depicts a block diagram of a non-limiting example process flow that can desirably employ feedback learning, model training, and configuration of components to facilitate managing and performing data resolution and data processing with logical representation of workflows to facilitate processing of requests for services, subscriptions, or products, in accordance with various aspects and embodiments of the disclosed subject matter.

FIG. 3 depicts a diagram of a non-limiting example electronic document of a request in an unstructured format, in accordance with various aspects and embodiments of the disclosed subject matter.

FIG. 4 illustrates a diagram of non-limiting example pseudocode for generation of the non-limiting conjunctive normal form (CNF) file with regard to this non-limiting example scenario, in accordance with various aspects and embodiments of the disclosed subject matter.

FIG. 5 presents a diagram of a non-limiting example table that can indicate respective interfaces that can be desired to be called, and can facilitate determining a sequence of calling desired respective interfaces, in connection with the non-limiting example scenario relating to a non-limiting example request, in accordance with various aspects and embodiments of the disclosed subject matter.

FIG. 6 illustrates a block diagram of a non-limiting example process flow that can desirably manage and perform data resolution and data processing, including entity recognition, to facilitate processing of requests for services, subscriptions, or products, in accordance with various aspects and embodiments of the disclosed subject matter.

FIG. 7 illustrates a flow chart of an example method that can desirably infer that an item of information in an electronic document can be an entity based at least in part on an artificial intelligence (AI)-based analysis, in accordance with various aspects and embodiments of the disclosed subject matter.

FIGS. 8 and 9 depict a flow chart of an example method that can desirably infer that an item of information in an electronic document can be an entity, based at least in part on an AI-based analysis, and update training of a trained model to recognize the item of information as being representative of the entity, in accordance with various aspects and embodiments of the disclosed subject matter.

FIG. 10 illustrates a flow chart of an example method that can desirably infer that respective items of information in an electronic document, comprising unstructured information, can be respective entities, based at least in part on an AI-based analysis, and update training of the trained model to recognize the respective items of information as being representative of the respective entities, in accordance with various aspects and embodiments of the disclosed subject matter.

FIG. 11 depicts a flow chart of an example method that can desirably perform data resolution, data enrichment, and other data processing, to facilitate creating a service or subscription model based at least in part on respective application entities and respective entity values that can be recognized or inferred from information contained in an electronic document associated with a request for a service, product, or subscription, and/or information obtained via interfaces, in accordance with various aspects and embodiments of the disclosed subject matter.

FIG. 12 illustrates an example block diagram of an example computing environment in which the various embodiments of the embodiments described herein can be implemented.

### DETAILED DESCRIPTION

Various aspects of the disclosed subject matter are now described with reference to the drawings, wherein like reference numerals are used to refer to like elements throughout. In the following description, for purposes of explanation, numerous specific details are set forth in order to provide a thorough understanding of one or more aspects. It may be evident, however, that such aspect(s) may be practiced without these specific details. In other instances, well-known structures and devices are shown in block diagram form in order to facilitate describing one or more aspects.

This disclosure relates generally to systems, methods, and techniques that can desirably (e.g., suitably, efficiently, reliably, enhancedly, and/or optimally) and autonomously perform data resolution with logical representation of workflows in connection with processing of electronic documents and information contained therein. Computer systems can be utilized to generate, process, and communicate electronic documents, including electronic documents associated with applications, word processing documents, message documents, chat documents, and/or other types of electronic documents, and information contained in such electronic documents. The electronic documents, and/or the information contained in the electronic documents, can be in a structured or unstructured format.

The processing of incoming requests and electronic documents (e.g., using a typical enterprise application) associated therewith usually can involve the calling of various application programming interfaces (APIs) and numerous workflows, including a messaging layer, microservices, and various technologies. For each variation in incoming requests, a new API typically has to be created, and for different data enrichment specifications (e.g., requirements) within the enterprise flow, numerous workflows may have to be developed. Using existing systems, techniques, and approaches, when new variations arise, additional APIs or workflows may have to be created. In larger organizations, these changes often can take many months (e.g., 6 to 8 months) of effort to create these new APIs and/or workflows. Another issue with these existing systems, techniques, and approaches can be that the disconnected workflows and the messaging layer may demand asynchronous processes to complete the enterprise logic, which may take considerable time to complete. Thus, existing systems, methods, techniques, and approaches can be deficient, inefficient, unsuitable, and/or otherwise undesirable in a number of ways.

As an illustrative example, consider a typical custom-built subscription management application in the supply chain environment. A customer can place an order in a sales application, and the sales application can create the order, such as an order for a subscription for a service or a product. The subscription order can be sent to a subscription application via an API call or a messaging queue. There can be different types of subscriptions that can be created based on the input data values, which can involve (e.g., want or require) data enrichment, such as customer details, product details, and other subscription details before the subscription can be created. For each subscription type, it can be desirable (e.g., wanted, needed, or required) to create an independent workflow. This workflow can enrich the desired (e.g., wanted or necessary) data by calling specific APIs that can be utilized (e.g., wanted or required) by the subscription process of the subscription application.

In certain organizations, there usually can be more than one sales application that each can have its own order detail structure and/or file format. Beyond this, an employee (e.g., partner, executive, salesperson, or other employee) of such an organization, from that employee's sales application, can send an order to the subscription application to create a subscription, where the order may be in a different format or schema (e.g., a different document or information format or schema) than the format or schema utilized or supported by the subscription application. For instance, the sales application may create the subscription as an extensible markup language (XML) file, but the subscription application in may support electronic documents, such as subscription documents, that are JavaScript Object Notation (JSON) files. Also different sales applications can represent entities (e.g., order number, item, item type, item description, quantity, and/or other entity) in the electronic documents in different ways. For example, an entity, such as order number, can be represented as Ord_Num in a first sales application, Ord_Number in a second sales application, and Order_Num in a third sales application.

Further, with existing technology in the modern world, a person can utilize a chat interface to place a subscription application in an unstructured and/or natural language format. Since received subscription orders may be in a different structured or unstructured schema or format than the schema or format utilized by the subscription application, as and when new sales input (e.g., new subscription orders in whatever different structured or unstructured format) is received by the subscription application, the subscription application may have to create one or more new and/or different APIs to resolve the fields (e.g., entities) that the subscription application can desire (e.g., want or need) to process and fulfill, or at least facilitate fulfillment of, the received subscription application. With different sales applications and/or chat interfaces providing data to the subscription application in different schemas or formats, this can lead to the subscription application having to create or utilize different APIs for each sales application and/or chat interface, and/or having to implement or utilize a different adapter pattern for each sales application and/or chat interface. Further, any changes in an existing field name or schema structure, from a sales application, can result in (e.g., can require) a code change in or at the API level, wherein such changes may occur quite frequently.

Furthermore, with regard to subscriptions, there can be respective (e.g., different) subscription types, and it can be desirable (e.g., wanted or required) for respective (e.g., different) workflows to be created for the respective subscription types, and it can be desirable (e.g., wanted or required) to call respective APIs to enrich the data for subscription creation with respect to the respective subscriptions of respective subscription types. If there are any changes desired (e.g., wanted or required) in the existing workflow development and/or a new subscription type is desired (e.g., wanted or required), it can be desirable (e.g., wanted or required) to create a new or modified workflow.

As can be seen from the foregoing, typical existing workflow-based enterprise applications (e.g., existing subscription or other type of existing workflow-based enterprise applications) can be designed to accept fixed-contract based APIs and defined workflows for each of the variations in the respective services or goods offered, provided, or facilitated by an organization (e.g., a business, a medical provider, a law enforcement agency, a military agency, an emergency service provider, or other organization). Any change in the input structure or values, change in the existing workflow, and/or change in the organization logic can involve (e.g., can require or need) development work in order to cater to or support such changes. This development work frequently can be undesirably time consuming, resource consuming, and/or costly, and can undesirably (e.g., negatively) impact the time to market to implement such changes and the ability of the organization to be competitive in the market with regard to the respective variations or changes associated with the organization.

It can be desirable (e.g., suitable, beneficial, advantageous, useful, improved, or optimal) to enhance performance of a computer system utilized to process requests for services, products, or subscriptions, enhance (e.g., improve or increase the efficiency, accuracy, and reliability of) the processing of requests for services, products, and/or subscriptions, reduce the amount of time, the amount of resources, and costs (e.g., financial costs or other type of cost) associated with processing and fulfilling requests for services, products, and/or subscriptions, and/or provisioning of services, products, and/or subscriptions associated with such requests.

Accordingly, the disclosed subject matter can address and overcome the aforementioned deficiencies and other deficiencies of the existing systems and techniques. To that end, techniques that can desirably (e.g., autonomously, automatically, dynamically, suitably, reliably, efficiently, enhancedly, and/or optimally) manage and perform data resolution and data processing with logical representation of workflows to facilitate processing of requests for services, subscriptions, or products are presented. A system can comprise a data resolution and processing management (DRPM) component that can desirably manage and perform such data resolution and data processing with logical representation of workflows. The DRPM component can receive electronic documents (e.g., electronic document associated with an application, an electronic message, an electronic chat interface document, or other type of electronic document) from devices (e.g., computer, mobile or smart phone, electronic pad or table, or other type of device). The electronic documents, and items of information therein, can be in a structured form or unstructured form.

With regard to an electronic document received from a device (e.g., in connection with a request for a service, product, or subscription), the DRPM component, employing an entity recognition component, can analyze the received electronic document. If the results of the analysis indicate that at least some of the items of information of the electronic document correspond to a document schema of a group of document schemas (e.g., JSON, XML, or other document schema), the entity recognition component can determine that the electronic document is in a structured format, and can process, or at least attempt to process, the electronic document in accordance with the document schema. From the respective items of information in the electronic document, the entity recognition component can identify and/or extract, or at least attempt to identify and/or extract, respective application entities (e.g., order number, product identifier (ID), item description, quantity, and/or other application entity) and respective values (e.g., order number value, product ID value, item description value, quantity value, and/or other value) associated with the respective application entities, in accordance with the document schema. Application entities also can be referred to as entities, named entities, or request entities.

If the entity recognition component is able to identify and extract the desired respective application entities and associated respective values from the items of information of the electronic document, in accordance with the document schema, the DRPM component can continue to process the request to create the desired (e.g., requested) service model (e.g., service or subscription model type), such as described herein. If, instead, the entity recognition component is not able to identify and/or extract one or more of the desired application entities from the items of information of the electronic document, with regard to each of the one or more missing (e.g., unidentified) application entities, the entity recognition component can employ a trained model (e.g., trained entity recognition model) that can infer or determine, or at least attempt to infer or determine, the application entity. The trained model, which can be an artificial intelligence (AI)-based model (e.g., AI, machine learning (ML), neural network, or other type of AI-based model), can be trained to recognize the respective application entities associated with the respective document schemas of the group of document schemas, the respective formats or structures of the respective document schemas, and respective versions (e.g., respective acceptable, understood, or recognized versions or variations that can be representative) of the respective application entities based at least in part on respective schema information relating to the respective schemas. The trained model can perform an analysis (e.g., AI-based analysis) on the respective items of information, or portion thereof, of the electronic document, and, based at least in part of the results of such analysis, the trained model can infer or determine that an item of information of the electronic document can be representative of the application entity (e.g., one of the one or more missing or unidentified application entities).

For example, if the trained model already has been trained to recognize a particular version (e.g., Prod_ID) that can be representative of the application entity (e.g., product ID), and the item of information is the particular version that can be representative of the application entity, the trained model can determine or infer that the item of information can be, or can be representative of, the application entity. If, instead, the item of information (e.g., ProdId) is not any of the one or more versions representative of the application entity that the trained model has been trained to recognize, the trained model can employ an AI-based analysis as part of the analysis of the electronic document by the trained model. Based at least in part of the results of the AI-based analysis, the trained model can infer or determine that the item of information (e.g., ProdId) can be representative of the application entity (e.g., product ID). The entity recognition component can present (e.g., communicate or display) inference information, which can indicate that the item of information is inferred or determined to be representative of the application entity. A user (e.g., an operator, a technician, or other user), using a device associated with the DRPM component or an interface of or associated with the DRPM component, can review or analyze the inference information to facilitate determining whether the inference that the item of information can be representative of the application entity is correct (e.g., accurate or acceptable). If the user determines that such inference is correct, the user, using the device or interface, can communicate, to the trained model, feedback information that can indicate such inference is correct (or, conversely, if the inference is determined to not be correct, the user can communicate different feedback information that can indicate such inference is not correct). If the inference is correct, the trained model can be updated (e.g., further trained), based at least in part on the inference and/or the feedback information (e.g., a rule that can be generated based at least in part on the inference and/or the feedback information), such that the trained model can recognize or determine that the item of information (e.g., if contained in a subsequent electronic document) can be an acceptable version (e.g., acceptable entity version) of the application entity that can be representative of the application entity, in accordance with the document schema (or in accordance with all or some of the respective document schemas of the group of document schemas). If, for some reason, the trained model is not able to generate an inference (e.g., an acceptable inference) with regard to an application entity, the entity recognition component or trained model can request feedback information from the user, where the feedback information can identify an item of information that can be representative of the application entity, and the trained model can be updated based at least in part on the feedback information. The entity recognition component can perform this process until all of the desired application entities are resolved (e.g., determined or identified).

If, instead, the entity recognition component determines that the electronic document is in an unstructured form (e.g., electronic document comprise items of information in a natural language form), the entity recognition component can employ the trained model to perform an AI-based analysis on the items of information of the electronic document to infer or determine the respective application entities. The trained model can present the inference information relating to the respective inferences that respective items of information can be representative of the respective application entities to the user. The user can review and/or analyze such inference information, and can communicate feedback information (e.g., feedback information confirming all or a portion of the inferences are correct; or, conversely, indicating that one or more of the inferences are not correct) to the entity recognition component and/or trained model. With regard to the respective items of information that are determined to be correctly representative of the respective application entities, the trained model can be updated (e.g., further trained), based at least in part on the respective inferences and/or the feedback information, such that the trained model can recognize or determine that the respective items of information (e.g., if contained in a subsequent electronic document) can be respective acceptable versions of the respective application entities that can be representative of the respective application entities, in accordance with the document schema (or in accordance with all or some of the respective document schemas of the group of document schemas).

With the respective application entities associated with the application and the request determined, the entity recognition component can determine, identify, or extract the respective values (e.g., respective application entity values) associated with the respective application entities from respective items of information (e.g., other respective items of information) of the electronic document based at least in part on the results of the analysis of the electronic document, in accordance with the document schema. For instance, the document schema can indicate where respective values can be located (e.g., what respective value fields) relative to the respective application entities (e.g., respective application entity fields) in the electronic document. In the case of an unstructured electronic document, as part of the AI-based analysis, the trained model can infer or determine the respective values associated with the respective application entities from respective items of information (e.g., other respective items of information) of the electronic document, similar to as described herein with regard to inferring application entities, wherein the user can provide feedback information to the entity recognition component and/or trained model to indicate whether the inferences of the respective values are correct or not.

With the respective application entities and associated respective values determined, the DRPM component can employ a resolver component that can utilize a logical model (e.g., logical resolver model) to facilitate resolving or determining a service type (e.g., a service or subscription type) associated with the request based at least in part on respective variables associated with the application, and the respective application entities and the associated respective values of the electronic document. In some embodiments, the logical model can employ or apply a satisfiability modulo theory (SAT)-conjunctive normal form (CNF) technique to the respective variables, the respective application entities, and the respective values to facilitate resolving or determining the service type associated with the request. As part of the resolver component employing the logical model and the SAT-CNF technique, the resolver component (or the logical model) can generate a CNF file to facilitate resolving the service type.

Based at least in part on the service type, the DRPM component can employ a data enricher determination component that can determine workflows to perform, respective interfaces (e.g., external or internal interfaces, such as APIs) to call, and a sequence of calling the respective interfaces to facilitate obtaining respective additional items of information relating to the request and the service type. In certain embodiments, the data enricher determination component can employ another logical model (e.g., a logical network matrix model) that can facilitate determining which interfaces to call and the sequence (e.g., the order) for calling the respective interfaces. The DRPM component can employ a data enricher component that can call the respective interfaces to obtain the respective additional information items. In some instances, the respective information items can comprise one or more additional respective application entities and/or one or more associated additional respective values that can be associated with the request and the service type. The DRPM component can employ a model creator component that can generate a service model (e.g., a service or subscription model type) based at least in part on the service type, the respective application entities, the respective values associated with (at least some of) the respective application entities, and the respective additional information items.

The disclosed subject matter, by employing the DRPM component and associated models, and the enhanced DRPM techniques described herein, can desirably (e.g., autonomously, automatically, dynamically, suitably, reliably, efficiently, enhancedly, and/or optimally) enhance (e.g., improve, increase, and/or optimize) performance of the computer system associated with the DRPM component, enhance training and performance (e.g., enhance inferences, determinations, and/or probability determinations) of AI-based models (e.g., the trained model and/or other AI-based model employed by the DRPM component), enhance (e.g., improve or optimize; and improve or increase the efficiency, accuracy, and reliability of) the processing of requests for services, products, and/or subscriptions, and reduce the amount of time, the amount of resources, and costs (e.g., financial costs or other type of cost) associated with processing requests for services, products, and/or subscriptions, and creating service models to facilitate fulfilling such requests, and/or provisioning of services, products, and/or subscriptions associated with such requests.

These and other aspects and embodiments of the disclosed subject matter will now be described with respect to the drawings.

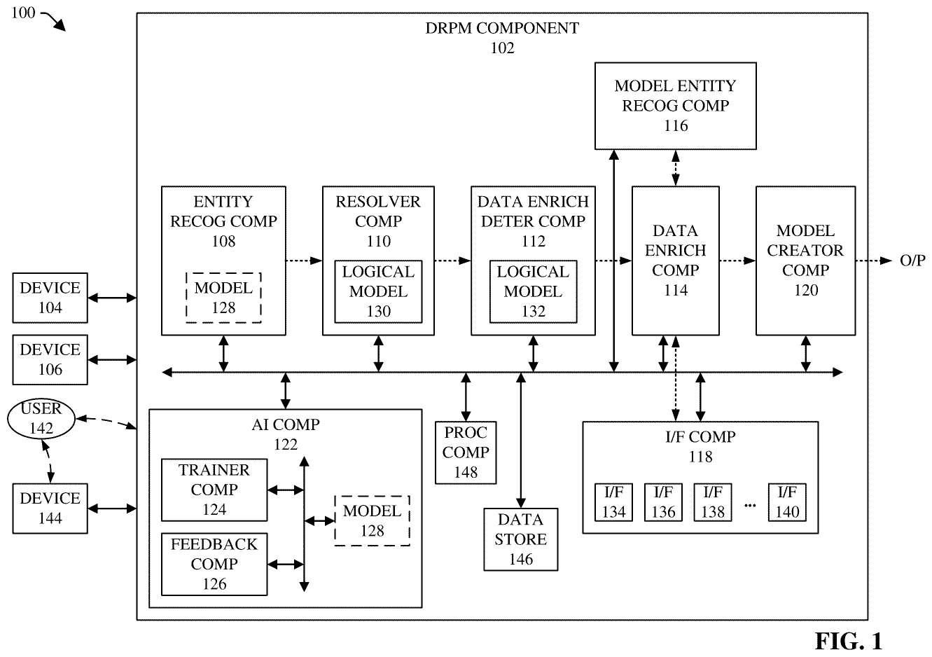

Referring now to the drawings, FIG. 1 illustrates a block diagram of a non-limiting example system 100 that can desirably (e.g., autonomously, automatically, dynamically, suitably, reliably, efficiently, enhancedly, and/or optimally) manage and perform data resolution and data processing with logical representation of workflows to facilitate processing of requests for services, subscriptions, or products, in accordance with various aspects and embodiments of the disclosed subject matter. In accordance with various embodiments, the system 100 can comprise a DRPM component 102 that can desirably manage and perform data resolution and data processing with logical representation of workflows to facilitate processing of requests for services, subscriptions, or products. The requests for services, subscriptions, or products can be received from one or more devices, such as, for example, device 104 and/or device 106, that can be associated with (e.g., communicatively connected to) the DRPM component 102 via a direct connection, or via a communication network with which the DRPM component 102 and the device(s) (e.g., 104 and/or 106) can be connected (e.g., via respective wireless or wireline communication connections). In accordance with various embodiments, the DRPM component 102 (e.g., respective components of the DRPM component 102) can be part of one or more devices.

A device (e.g., device 104, device 106, device(s) comprising the DRPM component 102, or other device) can be, for example, a computer, a laptop computer, a server, a wireless, mobile, or smart phone, an electronic pad or tablet, a virtual assistant (VA) device, electronic eyewear, an electronic watch, or other electronic bodywear, an electronic gaming device, an Internet of Things (IoT) device (e.g., a health monitoring device, a toaster, a coffee maker, blinds, a music player, speakers, a telemetry device, a smart meter, a machine-to-machine (M2M) device, or other type of IoT device), a device of a connected vehicle (e.g., car, airplane, train, rocket, and/or other at least partially automated vehicle (e.g., drone)), a personal digital assistant (PDA), a dongle (e.g., a universal serial bus (USB) or other type of dongle), a communication device, or other type of device.

In accordance with various embodiments, the DRPM component 102 can comprise an entity recognition component (ENTITY RECOG COMP) 108 (e.g., entity recognition engine), a resolver component (RESOLVER COMP) 110, a data enricher determination component (DATA ENRICH DETER COMP) 112 (e.g., data enricher determination engine), a data enricher component (DATA ENRICH COMP) 114, a model entity recognition component (MODEL ENTITY RECOG COMP) 116 (e.g., model entity recognition engine), an interface component (I/F COMP) 118, a model creator component (MODEL CREATOR COMP) 120, and an AI component (AI COMP) 122. In some embodiments, the AI component 122 can comprise a trainer component (TRAINER COMP) 124 and a feedback component (FEEDBACK COMP) 126, and can comprise or be associated with one or more models, such as model 128, which can be trained model (e.g., trained entity recognition model) employed by the entity recognition component 108. The trained model can be an AI-based model (e.g., AI, ML, neural network, or other type of AI-based model).

In certain embodiments, the resolver component 110 can comprise, employ, or be associated with a logical model 130 (e.g., logical resolver model) that can facilitate resolving or determining a service type (e.g., service or subscription type) associated with a request for a service, product, or subscription that is being processed. In some embodiments, the data enricher determination component 112 can comprise, employ, or be associated with a logical model 132 (e.g., logical network matrix model) that can facilitate determining which interfaces of the interface component 118 to call and a sequence for calling the respective interfaces of the interface component 118.

The interface component 118 can comprise a desired number (e.g., N) of external or internal interfaces, such as, for example, interface (I/F) 134, interface 136, interface 138, and/or (e.g., up through) interface 140 (e.g., interface), wherein N can be virtually any desired number. In accordance with various embodiments, one or more of the interfaces (e.g., 134, 136, 138, and/or 140) can be APIs. The respective interfaces (e.g., 134, 136, 138, and/or 140) of the interface component 118 can be utilized to access and/or obtain (e.g., retrieve) respective information items (e.g., respective additional application entities and/or associated respective entity values, and/or other desired information items) from respective data sources associated therewith, wherein the respective information items can be desired for or relevant to a request for a service, product, or subscription that is being processed.

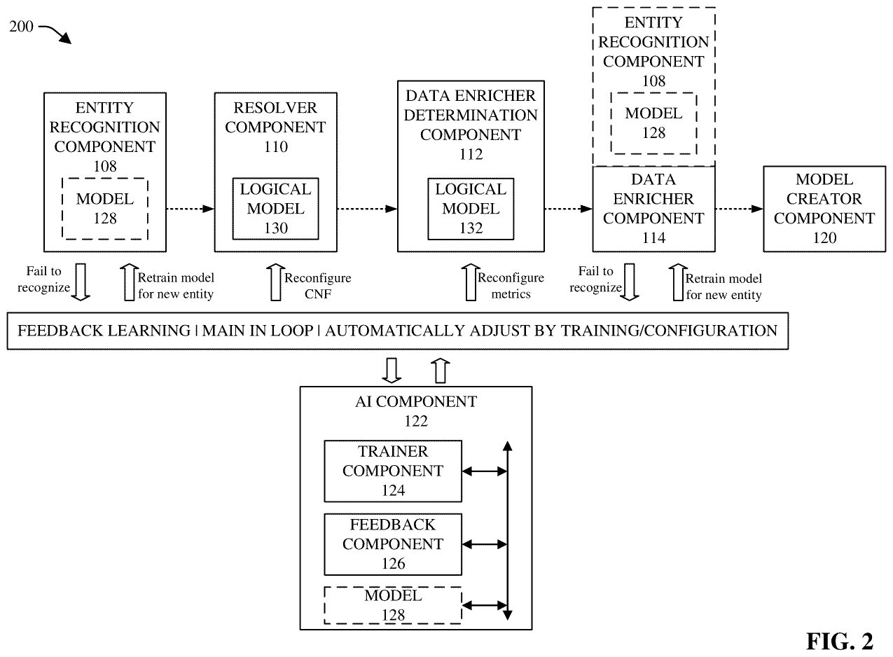

Referring to FIG. 2 (along with FIG. 1), FIG. 2 depicts a block diagram of a non-limiting example process flow 200 that can desirably (e.g., autonomously, automatically, dynamically, suitably, reliably, efficiently, enhancedly, and/or optimally) employ feedback learning, model training, and configuration of components to facilitate managing and performing data resolution and data processing with logical representation of workflows to facilitate processing of requests for services, subscriptions, or products, in accordance with various aspects and embodiments of the disclosed subject matter. The example process flow 200 can illustrate respective interactions between respective components of the DRPM component 102, including the entity recognition component 108, the resolver component 110, the logical model 130, the data enricher determination component 112, the logical model 132, the data enricher component 114, the model creator component 120, the AI component 122, and/or another component(s).

As disclosed, the DRPM component 102 can desirably manage and perform data resolution and data processing with logical representation of workflows to facilitate processing of requests for services, subscriptions, or products. The services, subscriptions, or products can relate to, for example, hospital, medical, and/or healthcare providers or services, law enforcement, emergency response providers or services, government agencies, manufacturing, industrial automation, retail or wholesale businesses, and/or other type of provider, service, business, agency, or organization. Some services, subscriptions, or products also can relate to data processing, data communications, computing resources, computer-related functions, and/or other type of data, communication, and/or computer related service. In some embodiments, the services, subscriptions, or products can relate to or involve hardware devices and equipment, software, or a combination thereof.

The DRPM component 102 can receive an electronic document from a device, such as the device 104. The electronic document can be in a structured format (e.g., using a defined document schema or other structured format) or an unstructured format (e.g., natural language form). In some embodiments, the electronic document can be generated by and received from an application (e.g., service, subscription, sales, or other type of application) of or associated with the device 104. In certain embodiments, the electronic document can be in the form of a message (e.g., email message, text message, instant message, chat message, or other type of electronic message. In certain instances, an electronic document can be generated in a chat or other messaging interface. In some instances, the electronic document can be generated from a paper document that has been scanned. In certain embodiments, if desired (e.g., wanted or needed) to identify the items of information in a document, the DRPM component 102 can perform optical character recognition on an electronic document or paper document to identify the items of information in the document.

The entity recognition component 108 can analyze the items of information in the received electronic document. The entity recognition component 108 can know what items of information (e.g., application entities, entity values, and/or other information) are desired (e.g., wanted or needed) to process the functions in connection with processing the request, based at least in part on the application (e.g., application being utilized by or associated with the DRPM component 102) and/or the service, subscription, or product associated with the request.

As a non-limiting example of a request for a subscription, a subscription application (e.g., utilized or associated with the DRPM component 102) can desire (e.g., want or need) the following data from the input data (e.g., items of information) received in a request for a service, subscription, or product:
OPID (organization purchase ID): alphanumeric value;
Order Number: alphanumeric value;
Customer ID: alphanumeric value;
Item: alphanumeric value;
Item Type: alphanumeric value;
Item Description: alphanumeric value;
Quantity: numerical value;
Contract Duration: numerical value (e.g., allowed values can be 1 or 3 (e.g., if billing cadence is Year), or 1, 3, 12, or 36 (e.g., if billing cadence is Month);
Billing Cadence: textual value (e.g., allowed values can be Monthly or Yearly);
Contract Type: textual value (e.g., allowed values can be Trial, Fixed Price, or
Consumption Based);
Contract Value: numerical value;
Price: numerical value.

It is to be appreciated and understood that, depending on the service, subscription, or product, the organization associated with the service, subscription, or product, the application(s) being utilized (e.g., by the DRPM component 102) to process the electronic document, and/or other factors, there can be different items of information (e.g., product ID or other different application entity), or more or less items of information, that can be desired to process the request than those items of information listed above.

Based at least in part on the results of such analysis, the entity recognition component 108 can determine whether the items of information contained in the electronic document of the request are in a structured format, such as a document schema of the group of document schemas (e.g., JSON, XML, comma-separated values (CSV), or other type of document schema), or an unstructured format (e.g., natural language format). In some embodiments, to facilitate determining whether the electronic document is in a structured format or unstructured format, as part of the analysis, the entity recognition component 108 can load the electronic document into one or more of respective document schema frameworks (e.g., document schema applications) associated with the respective document schemas. If a document schema framework returns an error, the entity recognition component 108 can determine that the electronic document is not structured in accordance with the document schema. If, instead, a particular document schema framework processes the electronic document and does not return an error, the entity recognition component 108 can determine that the electronic document is structured in accordance with (or at least substantially in accordance with) that particular document schema (e.g., even if one or more of the application entities may not be formatted in accordance with the particular document schema). If, instead, all of the document schema frameworks return an error, the entity recognition component 108 can determine that the electronic document is in an unstructured format.

If the entity recognition component 108 determines that the electronic document is structured in accordance with a document schema of the group of document schemas, the entity recognition component 108 and/or the trained model 128 can continue to process the electronic document to determine, identify, recognize, or infer application entities and/or associated values from the items of information of the electronic document, based at least in part on the document schema, such as described herein. If, instead, the entity recognition component 108 determines that the electronic document is unstructured, the entity recognition component 108 can employ the trained model 128 to facilitate inferring, determining, or recognizing application entities and/or associated values from the items of information of the electronic document, such as described herein.

In some embodiments, if the electronic document is determined to be in a structured format in accordance with (or at least substantially in accordance with) a document schema, based at least in part on the results of such analysis, the entity recognition component 108 can identify, determine, or recognize all or at least some of the application entities and/or associated values from the items of information contained in the electronic document, whether the electronic document is in a structured form or an unstructured form (e.g., natural language form). In certain embodiments, if one or more desired application entities are not identified by the entity recognition component 108, to facilitate identifying the one or more application entities in the electronic document, the entity recognition component 108 can employ the trained model 128 that can be trained to infer, determine, or recognize that an item of information in an electronic document can be representative an application entity, if such item of information is not in a form that is known or recognized for a document schema and/or is in an unstructured form, such as described herein. For instance, the trained model 128 can be trained or updated (e.g., by the AI component 122) based at least in part on certain entities (e.g., custom entities) that can be acceptable or recognized application entity versions (e.g., Product_ID, Prod_ID, ProdID) that can be representative of an application entity (e.g., product ID, which, for example, can have Product_ID as a primary application entity version), wherein such training and updating of the trained model 128 can be performed with regard to any desired application entities, and with regard to one or more of the respective document schemas of the group of document schemas. In this way, the trained model 128 can enable the entity recognition component 108 to desirably identify, determine, or recognize application entities and/or associated values from the items of information contained in the electronic document, even if some of the items of information are not in accordance with an applicable document schema or even if the items of information are in an unstructured format.

If, based at least in part on the analysis, the entity recognition component 108 is able to identify (e.g., determine or recognize) the desired application entities from the items of information in the electronic document (e.g., by loading the electronic document into the document schema framework and having the document schema framework analyze and process the electronic document), the entity recognition component 108 can obtain the desired respective application entities, identify, determine, and/or extract respective values associated with the respective application entities from other items of information contained in the electronic document, and map the respective application entities and associated values to an entitlement entity associated with the application and/or associated with the service, subscription, or product. In such case, the entity recognition component 108 does not have to employ the trained model 128 to facilitate identifying any application entities. The DRPM component 102 can continue to process the request, using the respective application entities and associated respective values, to create the desired (e.g., requested) service model (e.g., service or subscription model type), such as described herein.

In some example instances, the electronic document may have been generated using a first application (e.g., sales application) that may use a particular document schema (e.g., JSON schema), but may represent a certain application entity in a different manner than how a second application (e.g., service or subscription application) associated with the DRPM component 102 represents that certain application entity for the particular document schema. As a result, the entity recognition component 108 may be able to determine that the electronic document corresponds or at least substantially corresponds to the particular document schema, but initially may not be able to recognize the certain application entity in the electronic document. There also may be other reasons why the entity recognition component 108 initially may not be able to recognize the certain application entity in the electronic document.

Accordingly, if, instead, based at least in part on the analysis, the entity recognition component 108 is not able to identify and/or extract one or more of the desired application entities from the items of information of the electronic document (e.g., if validation of the electronic document, with regard to one or more desired application entities, by the document schema framework employed by the entity recognition component 108 fails), with regard to each of the one or more missing (e.g., unidentified) application entities, the entity recognition component 108 can employ the trained model 128 that can infer or determine, or at least attempt to infer or determine, the application entity. The trained model 128 can be trained (e.g., by the trainer component 124 of the AI component 122) to recognize the respective application entities associated with the respective document schemas of the group of document schemas, the respective formats or structures of the respective document schemas (e.g., JSON, XML, CSV, and/or other types of document schemas), and respective versions (e.g., respective acceptable, understood, or recognized versions or variations that can be representative) of the respective application entities based at least in part on respective schema information relating to the respective document schemas of the group of document schemas.

As a non-limiting example, with regard to an application entity that can be “product ID,” the primary acceptable version of the application entity that can be recognized by the document schema framework can be “Product_ID.” The document schema framework is able to recognize and process “Product_ID” if it is in an electronic document. However, if the electronic document has an item of information that is a variation of the term, such as “Prod_ID,” the document schema framework is not able to recognize “Prod_ID” as being representative of “product ID.” The trainer component 124 can train the trained model 128 to recognize the primary acceptable version of the application entity and one or more acceptable secondary versions of the application entity based at least in part on inputting or applying training data to the trained model 128 (and analysis of such training data by the trained model 128). For example, with regard to “product ID,” the trainer component 124 can train the trained model 128 to recognize “Product_ID,” “Prod_ID,” and “ProdID” as being representative of “product ID” based at least in part on training data relating to “Product ID,” “Prod_ID,” and “ProdID.” Such example training data can be as follows:

| | |
|---|---|
| 1 | TRAIN_DATA = [ |
| 2 | (“Product_ID”, {“entities”: [(23, 29, “Product_ID)]}), |
| 3 | (“Prod_ID”, {“entities”: [(23, 26, “Product_ID)]}), |
| 4 | (“ProdID”, {“entities”: [(23, 26, “Product_ID)]}), |
| 5 | ----- |
| 6 | ----- |
| 7 | ] |

This example training data can include all accepted and/or expected representations of product ID (e.g., for the document schema and/or one or more of the other document schemas) that can be mapped to “Product_ID” as an application entity (e.g., named entity). The trainer component 124 can similarly train the trained model 128 to recognize other application entities that can relate to order details (e.g., order number), product or service details (e.g., item description, quantity, type of subscription, unit cost or price, total cost or contract value, or other product or service detail), customer details (e.g., customer ID), and/or other desired details.

The trained model 128 can perform an analysis on the respective items of information, or portion thereof, of the electronic document, and, based at least in part of the results of such analysis, the trained model can infer or determine that an item of information of the electronic document can be representative of the application entity (e.g., one of the one or more missing or unidentified application entities). For example, if the trained model 128 already has been trained to recognize a particular version (e.g., Prod_ID) that can be representative of the application entity (e.g., product ID), and the item of information is the particular version that can be representative of the application entity, the trained model 128 can determine or infer that the item of information can be, or can be representative of, the application entity. In this example instance, the trained model 128 does not have to perform a more intensive AI-based analysis on the item of information, since the trained model already has been trained (e.g., explicitly trained) to recognize that particular version that can be representative of the application entity (e.g., the trained model 128 can utilize or exercise its “muscle memory” to determine or infer that the item of information can be representative of the application entity).

If, instead, the item of information (e.g., ProdId) in the electronic document is not any of the one or more versions representative of the application entity that the trained model 128 has been trained to recognize, the trained model 128 can employ an AI-based analysis as part of the analysis of the electronic document. Based at least in part of the results of the AI-based analysis, the trained model 128 can infer or determine that the item of information (e.g., ProdId) can be representative of the application entity (e.g., product ID), even though the item of information (e.g., ProdId) does not satisfy (e.g., does not meet) a defined match criterion (e.g., does not precisely or exactly match) with regard to any of the accepted versions of product ID that the trained model 128 has been trained (e.g., explicitly trained) to recognize for product ID. In some embodiments, the trained model 128 can utilize a fuzzy logic-based scoring technique or system as part of the AI-based analysis of such input data to assess or determine the best co-relation (e.g., the highest scoring co-relation) meaning of the item of information (e.g., the most probable or likely application entity or value represented by such item of information), and can infer the application entity or value represented by the item of information, based at least in part on the AI-based analysis results. In other embodiments, additionally or alternatively, the trained model 128 can perform a different type of AI-based analysis on the items of information of the electronic document to facilitate rendering an inference regarding what application entity(ies) an item(s) of information represents.

The entity recognition component 108 or trained model 128 can present (e.g., communicate or display) inference information, which can indicate that the item of information (e.g., ProdId) is inferred or determined to be representative of the application entity. In some embodiments, the entity recognition component 108 or trained model 128 can communicate a message (e.g., email message, text message, chat message, or other type of message), comprising the inference information, to a user 142, or can otherwise communicate the inference information to the user 142 via a desired communication means or interface. The user 142 (e.g., an operator, a technician, or other user), using a device, such as device 144, associated with the DRPM component 102 or an interface of or associated with the DRPM component 102, can review or analyze the inference information to facilitate determining whether the inference that the item of information can be representative of the application entity is correct (e.g., accurate or acceptable). If the user 142 determines that such inference is correct, the user 142, using the device 144 or interface, can communicate, to the entity recognition component 108 or trained model 128 (and/or the AI component 122, via the feedback component 126), feedback information (e.g., approved representation of application entity for the document schema(s)) that can indicate such inference is correct (or, conversely, if the inference is determined to not be correct, the user 142 can communicate different feedback information that can indicate such inference is not correct). If the inference is correct, the trained model 128 can be updated (e.g., further trained by the trainer component 124), based at least in part on the inference and/or the feedback information (e.g., a rule that can be generated based at least in part on the inference and/or the feedback information), such that the trained model can recognize or determine that the item of information (e.g., if contained in a subsequent electronic document) can be an acceptable version (e.g., acceptable entity version) of the application entity that can be representative of the application entity, in accordance with the document schema (or in accordance with all or some of the respective document schemas of the group of document schemas). For example, the entity recognition component 108 or the AI component 122 can determine and generate a rule (e.g., can generate the rule in accordance with the document schema, or can generate respective rules in accordance with all or some of the document schemas) that can indicate or specify that the item of information (e.g., ProdId) can be an acceptable representation of the application entity (e.g., product ID), based at least in part on the inference information and the feedback information. In some embodiments, the entity recognition component 108 or the AI component 122 can determine and generate code, instructions, structure (e.g., document schema) information, and/or other information to facilitate generating and implementing the rule, wherein the rule can enable the trained model 128 (e.g., after being trained based at least in part on the rule) to desirably make recursive model calls, if and as desired (e.g., wanted or needed). The trainer component 124 can update the trained model 128 to recognize that the item of information (e.g., ProdId) can be an acceptable representation of the application entity (e.g., product ID), based at least in part on training data derived from the rule and applied to the trained model 128.

If a subsequent electronic document of a received request contains that item of information (e.g., ProdId), the trained model 128 does not have to perform an AI-based analysis to infer or determine that such item of information can be representative of the application entity (e.g., product ID), but rather can determine that the item of information can be representative of the application entity based at least in part on applying the knowledge the trained model 128 can have from its updated training. This desirably can save (e.g., reduce or minimize) the amount of time and resources utilized to determine that the item of information can be representative of the application entity, as the entity recognition component 108, the trained model 128, and/or the AI component 122, respectively, do not have to perform an AI-based analysis of the subsequent electronic document and generate an inference with regard to that application entity, do not have to communicate inference information relating to that application entity to the user 142, do not have to wait for and receive feedback information from the user 142 regarding such inference relating to the application entity, do not have to generate a rule relating to the inference and the feedback information with regard to the application entity, and do not have to update the training of the trained model 128 to recognize that the item of information can be representative of the application entity.

If, for some reason, the trained model 128 is not able to generate an inference (e.g., an acceptable inference) with regard to an application entity, the entity recognition component 108 or trained model 128 can request feedback information from the user 142, where the feedback information can identify an item of information in the electronic document that can be representative of the application entity (e.g., if there is an item of information in the electronic document that can be representative of the application entity), and the trained model 128 can be updated (e.g., by the trainer component 124) based at least in part on the feedback information (e.g., a rule generated based at least in part on the feedback information). The entity recognition component 108 and/or the trained model 128 can perform this process until all of the desired application entities are resolved (e.g., determined or identified) with regard to the electronic document. It is noted that, in some electronic documents of requests, there may be extraneous information that is not desired (e.g., not wanted or required) for the creation of the service or subscription. The entity recognition component 108 can disregard (e.g., ignore) or omit such extraneous information during processing of the request.

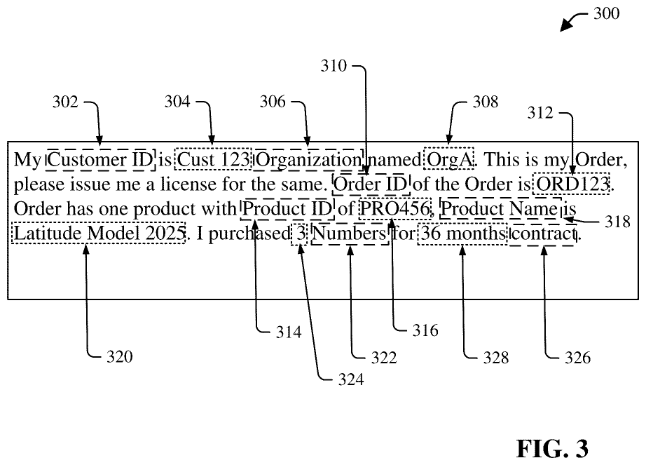

In some embodiments, if, instead, the entity recognition component 108 determines that the electronic document is in an unstructured form (e.g., electronic document comprise items of information in a natural language form), the entity recognition component 108 can employ the trained model 128 to perform an AI-based analysis on the items of information of the electronic document to infer or determine the respective application entities. Referring briefly to FIG. 3 (along with FIGS. 1 and 2), FIG. 3 depicts a diagram of a non-limiting example electronic document 300 of a request in an unstructured format (e.g., natural language format), in accordance with various aspects and embodiments of the disclosed subject matter. With regard to the example electronic document 300, the trained model 128 can perform an AI-based analysis on the items of information of the electronic document 300 to infer or determine the respective application entities and/or associated respective values from respective items of information contained in the electronic document 300. The trained model 128 can be trained to perform recognition processing on unstructured data, including performing natural language processing, and trained to recognize items of information that can be respective application entities and other items of information that can be respective values associated with the respective application entities, including being trained to be able to recognize where a value can be located or positioned relative to an associated application entity within the electronic document, and recognize respective formats (e.g., respective textual and/or alphanumeric formats) that the respective application entities and respective values can have. In some embodiments, the trained model 128 can be a spaCy implementation (e.g., using the spaCy library) that can enable the trained model 128 to desirably perform natural language processing, although, in other embodiments, the trained model 128 can be trained (e.g., by the trainer component 124) to perform natural language or other unstructured data processing based at least in part on other training data and/or other types of AI-based training implementations.

With regard to the electronic document 300, based at least in part on the results of the AI-based analysis, the trained model 128 can infer or determine that Customer ID 302 can be a first application entity and can be associated with first value, Cust 123 304, Organization 306 can be a second application entity and can be associated with a second value, OrgA 308, ORD ID 310 can be a third application entity and can be associated with a third value, ORD123 312, Product ID 314 can be a fourth application entity and can be associated with a fourth value, PRO456 316, Product Name 318 can be a fifth application entity and can be associated with a fifth value, Latitude Model 2025 320, Numbers 322 can be a sixth application entity and can be associated with a sixth value, 3 324, and Contract 326 can be a seventh application entity and can be associated with a seventh value, 36 months 328.

The trained model 128 can present the inference information relating to the respective inferences that respective items of information of the electronic document (e.g., electronic document 300) can be representative of the respective application entities to the user 142 (e.g., via device 144 or the interface). The user 142 can review and/or analyze such inference information, and can communicate feedback information (e.g., feedback information confirming all or a portion of the inferences are correct; or, conversely, indicating that one or more of the inferences are not correct and/or providing corrected identification of the application entities and/or the associated values) to the entity recognition component 108, trained model 128, and/or the AI component 122 (e.g., the feedback component 126). With regard to the respective items of information that are determined to be correctly representative of the respective application entities, the trained model 128 can be updated (e.g., further trained by the trainer component 124), based at least in part on training data or rules that can be determined and generated based at least in part on the respective inferences and/or the feedback information, such that the trained model 128 can recognize or determine that the respective items of information (e.g., if contained in a subsequent electronic document) can be respective acceptable versions of the respective application entities that can be representative of the respective application entities, in accordance with the document schema (or in accordance with all or some of the respective document schemas of the group of document schemas).

With the respective application entities and the respective values having been determined or resolved from the items of information in the electronic document by the entity recognition component 108 and/or trained model 128, the DRPM component 102 can map the respective application entities and associated values to the entitlement entity associated with the application and/or associated with the service, subscription, or product. In some embodiments, with the respective application entities and the respective values having been determined or resolved, the DRPM component 102 (e.g., utilizing a desired application) can employ the resolver component 110 to determine or identify the service model(s) and/or service type (e.g., service or subscription type) associated with the received request based at least in part on the respective application entities, the respective values, variables associated with the respective services, subscriptions, or products (e.g., service or subscription types), other input variables, and/or other information or constraints. In some embodiments, at this point, the DRPM component 102 can initiate or start using workflows. For instance, the DRPM component 102 can initiate or start using workflows, where the DRPM component 102 (e.g., employing the resolver component 110) can conduct a log of if/else conditions (e.g., Boolean conditions or other conditions) to facilitate determining the service model(s) and/or service type (e.g., service or subscription type) associated with the received request. For example, if the DRPM component 102 is employing a particular service or subscription application, it can be desirable for the resolver component 110 to identify or determine a service or subscription type associated with the received request.

In certain embodiments, the resolver component 110 can employ the logical model 130 to resolve the dependency of the input (e.g., the respective application entities, the respective values, and/or other input information) to determine or identify the service model(s) and/or service type (e.g., service or subscription type) associated with the received request. In some instances, and/or with regard to certain applications, the resolver component 110 may have to obtain (e.g., collect or retrieve) some additional attributes or information from a local entity (e.g., a local system), depending in part on the implementation.

In some embodiments, the resolver component 110 and/or the logical model 130 can employ the SAT-CNF technique to facilitate resolving or determining the service type (e.g., service or subscription type) associated with (e.g., requested by) the received request based at least in part on the respective application entities, the respective values, variables associated with the respective services, subscriptions, or products (e.g., service or subscription types), other input variables, and/or other information or constraints. The SAT problem can be a combinatorial problem. For instance, given a Boolean formula of nn variables:

$$f ( x 1 , x 2 , … , xn ) , f ( x 1 , x 2 , … , xn ) , \qquad ( Eq . ( 1 ) )$$

wherein the problem can be to find (e.g., determine) such respective values of the respective variables on which the Boolean formula can have a value equal to true.

The SAT-CNF problem can be a version of the SAT problem where the Boolean formula of Equation (Eq.) (1) can be specified in CNF, which can mean that it can be a conjunction of clauses, wherein a clause can be a disjunction of literals, wherein a literal can be a variable or its negations. For example:

$$( x 1 ∨ x 2 ) \& ( ¬ x 2 ∨ x 3 ∨ ¬ x 4 ) \& ( ¬ x 1 ∨ x 4 ) , \qquad ( Eq . ( 2 ) )$$

wherein x1, x2, x3, and x4 can be Boolean variables to be assigned, ¬ can mean negation (e.g., logical NOT), ∨ can mean disjunction (e.g., logical OR), and & can mean conjunction (e.g., logical AND). It can be noted that the formula of Eq. (2) can be satisfiable, because on x1=true, x2=false, x3=false, and x4=true, the formula of Eq. (2) can have the value of true. If a formula is not satisfiable, it can be referred to as unsatisfiable, which can mean that it can take on the value of false on any value of its variables.

In general, case translation of a CNF-SAT problem can result in the following 0-1 programming problem:

$$\sum j ∈ J + ixj - \sum j ∈ J - ixj \geq 1 - \vert J - i \vert , i = 1 , … , m , \qquad ( Eq . ( 3 ) )$$

$$xj ∈ \{ 0 , 1 \} , j = 1 , … , n ,$$

wherein n can be the number of variables, m can be the number of clauses (inequality constraints), J+i⊆{1, . . . ,n} can be a subset of variables, whose literals in the i^{th} clause do not have negation, and J−i⊆{1, . . . ,n} can be a subset of variables, whose literals in the i^{th} clause can be negations of such variables. It can be assumed that J+i∩J−i=Ø for all i.

With regard to further non-limiting example details of a non-limiting example of the SAT and CNF approach, subscription types that can be expected (e.g., can be valid) can be defined as follows:

### Variables:

Subscription Types (for organization software only):
S1: Fixed Price, Monthly, 1 Year;
S2: Fixed Price, Monthly, 3 Year;
S3: Fixed Price, Yearly, 1 Year;
S4: Fixed Price, Yearly, 3 Year;
S5: Consumption Based, Monthly, 1 Year;
S6: Consumption Based, Monthly, 3 Year;
S7: Consumption Based, Yearly, 1 Year;
S8: Consumption Based, Yearly, 3 Year;
S9: Consumption Based, Trial, 3 Months;
S10: Fixed Price, Trial, 3 Months;

The input variables can be defined as follows:

### Input Variables:

ItemType_OrganizationSoftware: True if Item Type is Organization Software;
ContractType_FixedPrice: True if Contract Type is Fixed Price;
ContractType_ConsumptionBased: True if Contract Type is Consumption Based;
BillingCadence_Monthly: True if Billing Cadence is Monthly;
BillingCadence_Yearly: True if Billing Cadence is Yearly;
ContractDuration_1: True if Contract Duration is 1 year/month;
ContractDuration_3: True if Contract Duration is 3 year/month;
ContractDuration_3Months: True if Contract Duration is 3 months;
ContractType_Trial: True if Contract Type is Trial.

The CNF Clauses can be defined as follows:

### Item Type Constraint:

˜ItemType_OrganizationSoftware OR (S1 OR S2 OR S3 OR S4 OR S5 OR S6 OR S7 OR S8 OR S9 OR S10): If it is Organization Software, one of the Organization Software subscription types has to be true.
Contract Type Constraints:
˜ContractType_FixedPrice OR (S1 OR S2 OR S3 OR S4)
˜ContractType_ConsumptionBased OR (S5 OR S6 OR S7 OR S8 OR S9 OR S10)

### Billing Cadence Constraints:

˜BillingCadence_Monthly OR (S1 OR S2 OR S5 OR S6)
˜BillingCadence_Yearly OR (S3 OR S4 OR S7 OR S8 OR S9)

### Contract Duration Constraints:

˜ContractDuration_1 OR (S1 OR S3 OR S5 OR S7)
˜ContractDuration_3 OR (S2 OR S4 OR S6 OR S8 OR S9)
˜ContractDuration_3Months OR (S10)

### Trial Constraints:

˜ContractType_Trial OR (S10)

### Exclusivity Constraint:

(˜S1 OR ˜S2 OR ˜S3 OR ˜S4 OR ˜S5 OR ˜S6 OR ˜S7 OR ˜S8 OR ˜S9 OR ˜S10): Only one subscription type can be true.

With these CNF clauses and rules (e.g., as can be determined by the resolver component 110 and/or the logical model 130), the resolver component 110 and/or the logical model 130 can determine and/or generate a corresponding (e.g., compatible or conforming) CNF file using desired CNF file generation tools and techniques. As a non-limiting example, the resolver component 110 and/or the logical model 130 can determine and/or generate a non-limiting CNF file (e.g., with regard to the above example scenario) as follows:

$$CNF File :$$

$$p \qquad cnf \qquad 15 \qquad 16$$

$$1 \qquad - 2 \qquad - 3 \qquad - 4 \qquad - 5 \qquad - 6 \qquad - 7 \qquad - 8 \qquad - 9 \qquad - 10 \qquad 0$$

$$2 \qquad - 12 \qquad 0$$

$$3 \qquad - 13 \qquad 0$$

$$4 \qquad - 14 \qquad 0$$

$$5 \qquad - 15 \qquad 0$$

$$6 \qquad - 12 \qquad - 13 \qquad 0$$

$$7 \qquad - 14 \qquad - 15 \qquad 0$$

$$8 \qquad - 13 \qquad 0$$

$$9 \qquad - 14 \qquad 0$$

$$10 \qquad - 12 \qquad - 13 \qquad 0$$

$$11 \qquad - 14 \qquad - 15 \qquad 0$$

$$12 \qquad - 1 \qquad 0$$

$$13 \qquad - 1 \qquad 0$$

$$14 \qquad - 1 \qquad 0$$

$$15 \qquad - 1 \qquad 0$$

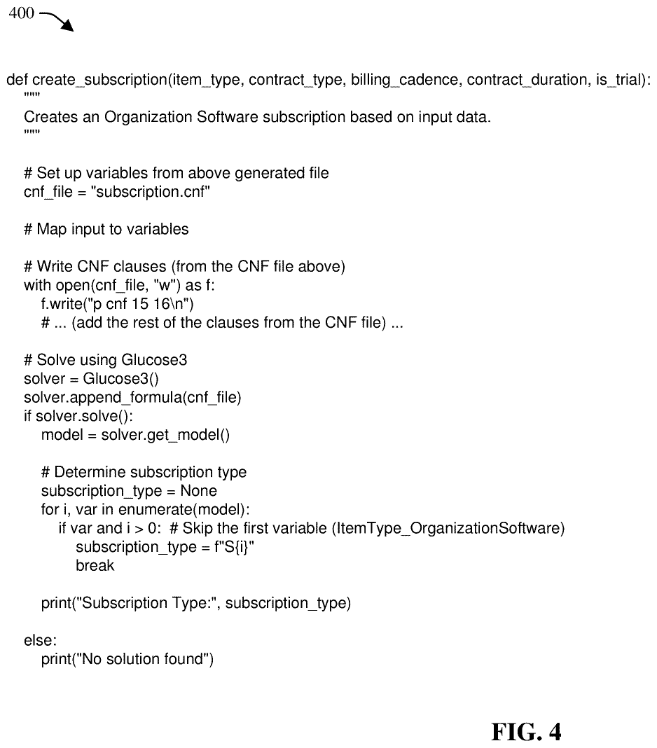

With this example CNF file, the resolver component 110 and/or the logical model 130 can desirably (e.g., quickly, efficiently, accurately, reliably, enhancedly, or optimally) resolve or determine the subscription type for this non-limiting example scenario (e.g., can desirably resolve or determine the subscription type on the order of milliseconds). Referring briefly to FIG. 4 (along with FIGS. 1 and 2), FIG. 4 illustrates a diagram of non-limiting example pseudocode 400 for generation of the non-limiting CNF file with regard to this non-limiting example scenario, in accordance with various aspects and embodiments of the disclosed subject matter.

It is to be appreciated and understood that, while, in some embodiments, the resolver component 110 and/or the logical model 130 can utilize the SAT-CNF techniques and processes to resolve or determine the service or subscription type associated with a received request for a service, subscription, or product, in other embodiments, the resolver component 110 and/or the logical model 130 can utilize another desired technique(s) and process(es) to resolve or determine the service or subscription type associated with a received request for a service, subscription, or product.

Once the DRPM component 102 determines or knows the service or subscription type associated with the received request, and/or the service model type to be created in connection with the received request, it may be desirable (e.g., wanted or needed) for the DRPM component 102 to obtain (e.g., collect or retrieve) additional or external data (e.g., additional or external product information, customer information, and/or other information) to facilitate processing and fulfilling the request. If there is additional or external data to be obtained in connection with processing the received request, it can be desirable (e.g., wanted or needed) to utilize respective external or internal interfaces, such as respective APIs (e.g., modular APIs), to facilitate obtaining such additional or external data. For each of the respective service model types (e.g., service or subscription model types), there can be a respective sequence of calling of interfaces (e.g., APIs), which can vary between respective service model types. In some embodiments, the calling of the respective interfaces (e.g., interface 134, 136, 138, and/or 140), in accordance with the sequence, can be part of the workflow associated with processing the received request. In certain embodiments, for each service model, there typically can be a respective (e.g., different) workflow, and, if there is a new service model type, there can be a respective (e.g., unique) workflow determined or created for that new service model type.

In some embodiments, the DRPM component 102 can employ the data enricher determination component 112 and/or the logical model 132 to determine the respective workflows to be performed, the respective interfaces (e.g., interface 134, 136, 138, and/or 140) to be called, and/or the sequence of calling the respective interfaces, based at least in part on the results of analyzing information relating to the service or subscription type associated with the received request, and/or the service model type to be created in connection with the received request.

In certain embodiments, the data enricher determination component 112 and/or the logical model 132 can utilize a network matrix technique (e.g., NXM technique or concept) to determine the interface (e.g., API) dependency for the service model type, and/or service or subscription type, associated with the received request (e.g., determine the respective workflows to be performed, the respective interfaces to be called, and/or the sequence of calling the respective interfaces to facilitate obtaining the desired additional or external data).

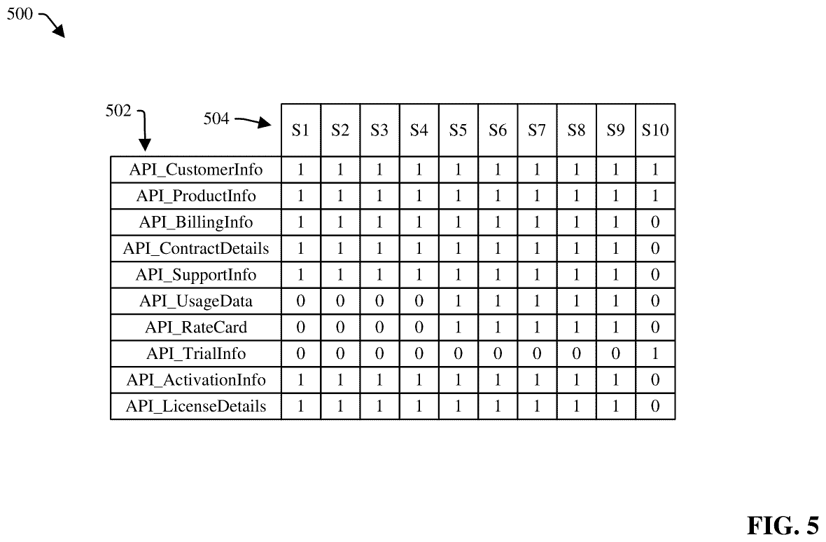

Referring briefly to FIG. 5 (along with FIGS. 1-4), FIG. 5 presents a diagram of a non-limiting example table 500 that can indicate respective interfaces (e.g., APIs) that can be desired to be called, and can facilitate determining a sequence of calling desired respective interfaces, in connection with the non-limiting example scenario relating to a non-limiting example request, in accordance with various aspects and embodiments of the disclosed subject matter. In this non-limiting example scenario, and with regard to the non-limiting example table 500, the rows 502 of the table 500 can represent the respective APIs (e.g., API for customer information (API_CustomerInfo), API for product information (API_ProductInfo), API for billing information (API_BillingInfo), and other APIs, such as depicted in table 500) that can be available to be called. The columns 504 of the table 500 can represent the non-limiting example subscription types (e.g., S1, S2, S3, S4, S5, S6, S7, S8, S9, and S10), such as described herein. In some embodiments, the respective entries in the respective cells of the table 500 can indicate a “1” value in a cell to indicate that the API associated with that row and cell can be called (e.g., it can be wanted or needed to call that API) with respect to the subscription type associated with that column and cell; and, conversely, a “0” value in a cell can indicate that the API associated with that row and cell does not have to be called with respect to the subscription type associated with that column and cell. It is to be appreciated and understood that, in other embodiments, the entry values can be different than above (e.g., a “0” value in a cell can indicate that the associated API is to be called and a “1” value in a cell can indicate that the associated API does not have to be called, with respect to the associated subscription type).

With regard to the sequence of calling of APIs, the order of the APIs in the rows 502 can indicate or determine the sequence of calling of the APIs. It is to be appreciated and understood that the ordering of the respective APIs in the rows 502 of the table 500 is a non-limiting example ordering of APIs, and the APIs can be in a different order, and/or there can be different APIs, depending in part on the application being employed by the DRPM component 102, the respective services, subscriptions, or products that can be requested, the respective APIs that can be available for calling, and/or other factors. With regard to the table 500, the example APIs can include, API_CustomerInfo that can be utilized (e.g., called) to obtain customer information regarding the customer associated with the request, API_ProductInfo that can be utilized to obtain product information associated with the request, API_BillingInfo that can be utilized to obtain billing information associated with the request or customer, API_ContractDetails that can be utilized to obtain additional detail information associated with the contract associated with the request, API_SupportInfo that can be utilized to obtain additional support information associated with the request, API_UsageData that can be utilized to obtain usage data-related information associated with the request, API_RateCard that can be utilized to obtain rate card-related information associated with the request, API_TrialInfo that can be utilized to obtain trial subscription-related information associated with the request, API_ActivationInfo that can be utilized to obtain activation-related information (e.g., for activation of the service, subscription, or product) associated with the request, and API_LicenseDetails that can be utilized to obtain license-related information associated with the request. In some embodiments, there may be other APIs (e.g., API_Subscription Create that can be called to facilitate creating the subscription associated with the request) that can utilized by the logical model 132 (e.g., can be included in the table or matrix as part of the logical model 132).

In certain embodiments, the APIs for customer information and product information can be APIs that usually can be utilized for all or virtually all types of services, subscriptions, or products; the APIs for billing information, contract details, support information, and license details often can be utilized (e.g., probably or likely can be wanted or needed) for non-trial services, subscriptions, or products; the APIs for usage data and rate card typically can be utilized for consumption-based subscriptions (e.g., S5-S9); the API for trial information typically can be utilized for trial subscriptions (e.g., S10); and the API for activation information typically can be utilized for certain types of services, subscriptions, or products.

In some instances, depending in part on the sequence of calling of the interfaces, two or more the interfaces (e.g., APIs) can be called in parallel (e.g., concurrently or simultaneously) to facilitate obtaining the respective additional items of information in parallel via the two or more respective interfaces. For instance, with regard to a Z dimension of the network matrix represented in the example table 500, the Z dimension can indicate or specify whether the node can be allowed for parallel processing. For example, in table 500, and with regard to subscription S10, API_BillingInfo, API_ContractDetails, and API_SupportInfo can be called in parallel (e.g., using or as executed by the data enricher component 114), and other APIs that are to be called can be called (e.g., individually, using or as executed by the data enricher component 114), from the top rows down to the bottom rows of the table 500, in accordance with the sequence.

With the determining of the respective workflows to be performed, the respective interfaces to be called, and/or the sequence of calling the respective interfaces to facilitate obtaining the desired additional or external data, the data enricher component 114 can call or execute the respective external or internal interfaces (e.g., APIs or other interfaces) of the interface component 118 (e.g., interfaces 134, 136, 138, and/or 140) in accordance with the sequence determined by the data enricher determination component 112 with regard to the received request and the service or subscription type, and/or the service model type, associated with the received request. The respective interfaces (e.g., 134, 136, 138, and/or 140) can obtain the respective additional items of information (e.g., additional application entities, additional entity values, and/or other desired additional items of information) from respective data sources associated with the respective interfaces. In some embodiments, the model entity recognition component 116 can facilitate identifying or determining some of the additional items of information (e.g., additional application entities) that can be desired to be obtained (e.g., by the data enricher component 114 via the interfaces) with regard to the received request and the service or subscription type, and/or the service model type, associated with the received request. For example, with regard to the customer information API (e.g., API_CustomerInfo), the data enricher component 114 and/or the model entity recognition component 116 can know or determine that the service or subscription process can desire certain additional items of information, such as customer name and customer country, from the customer information API. The trained model 128 of the entity recognition component 108 can be trained to recognize each of the respective application entities and associated respective values (e.g., respective entity values) from the responses of the respective APIs to the respective API calls associated with the sequence.

The model creator component 120 can receive the respective application entities and the associated respective values, the respective additional application entities and the associated respective additional values, and/or other desired information (e.g., other items of information and/or other additional items of information) from the data enricher component 114 and/or another component (e.g., entity recognition component 108, interface component 118, or other component of or associated with the DRPM component 102). The model creator component 120 can generate (e.g., create) the service model (e.g., service or subscription model type), based at least in part on the respective application entities and the associated respective values, the respective additional application entities and the associated respective additional values, and/or the other desired information, to facilitate processing and/or fulfilling the request for the service, product, or subscription. For instance, the model creator component 120 can arrange the respective information items (e.g., the respective application entities, the associated respective values, the respective additional application entities, the associated respective additional values, and/or the other desired information) in the desired (e.g., wanted or needed) order or structure (e.g., format) to create the desired service model associated with the request. The model creator component 120 can present (e.g., communicate or display) information relating to the service model for the request as an output (O/P) and/or can store the information relating to the service model in a data store 146.

The DRPM component 102, thus, can desirably process requests for services, products, or subscriptions, and generate desired service models for those requests. The DRPM component 102, employing the entity recognition component 108 and trained model 128, can desirably (e.g., quickly, efficiently, accurately, enhancedly, or optimally) take virtually any form of input data and recognize or infer application entities and/or associated values from the input data. The DRPM component 102, employing the resolver component 110, can desirably (e.g., quickly, efficiently, accurately, enhancedly, or optimally) derive the service or subscription type, and/or the service model type, using the logical model 130 (e.g., employing the disclosed SAT-CNF process). The DRPM component 102, employing the data enricher determination component 112, can desirably (e.g., quickly, efficiently, accurately, enhancedly, or optimally) derive or determine the desired or dependent external or internal interfaces (e.g., APIs) that have to be executed (e.g., called), the sequence of calling of the interfaces, and whether and which interfaces (if any) can be called in parallel as part of the sequence, using the logical model 132 (e.g., the network matrix model), and based at least in part on the service or subscription type for the request and the available interfaces. The DRPM component 102, employing the data enricher component 114, the model entity recognition component 116, and the interface component 118, can orchestrate, call, and/or execute the interfaces (e.g., 134, 136, 138, and/or 140), such as APIs, in accordance with the sequence determined by the data enricher determination component 112 and/or the logical model 132. The DRPM component 102, employing the entity recognition component 108, the trained model 128, and/or the model entity recognition component 116, can determine, identify, or recognize the desired additional items of information (e.g., the respective additional application entities, the associated respective additional values, and/or the other desired additional items of information) from the respective data obtained from the respective responses of the interfaces to the calls during execution of the sequence. The DRPM component 102, employing the model creator component 120, can desirably (e.g., quickly, efficiently, accurately, enhancedly, or optimally) generate the service model (e.g., service or subscription model type), based at least in part on the respective application entities and the associated respective values, the respective additional application entities and the associated respective additional values, and/or the other desired information, to facilitate processing and/or fulfilling the request for the service, product, or subscription.

The processes and models employed by the DRPM component 102 can enable the DRPM component 102 to process requests for services, products, or subscriptions autonomously, and much more quickly and accurately than existing request processing systems, methods, and techniques. The entity recognition process, the process for determining the service or subscription type, and the process for deriving the dependent APIs that have to executed can be performed on the order of milliseconds or even faster (e.g., since such processes can be based in part on logical or mathematical derivation, rather than workflow initialization). If the execution speed of APIs is sufficiently fast, the whole service or subscription creation process can be performed on the order of seconds (e.g., two seconds or less), rather than on the order of minutes (e.g., five or ten minutes).

In some embodiments, the autonomous features of the DRPM component 102 can be utilized to take and resolve virtually any variation of input data (e.g., received with a request for a service, product, or subscription). For example, if subsequently, another user (e.g., a new partner or customer) uses an application (e.g., the other user's application) to generate a request for a service, product, or subscription, or a service or subscription creation, in a format of that application that is different from the formats and schemas employed by the DRPM component 102, the entity recognition component 108 and trained model 128, using the techniques and processes disclosed herein, can desirably (e.g., autonomously, automatically, dynamically, suitably, reliably, efficiently, enhancedly, and/or optimally) understand, recognize, and/or infer the application entities and/or associated values desired (e.g., wanted or required) to process the request from the input data of the request, and can extract the application entities and/or associated values from the input data of the request, provided that such application entities and/or associated values are contained in the input data of the request. If there is a new rule change in the service or subscription type, the vast majority of the time (e.g., approximately 90% of the time), such change can be CNF file changes, and the DRPM component 102 can be adapted (e.g., modified or updated) to handle such changes. If there is a new API to be added in the orchestration for the system (e.g., system 100), the DRPM component 102 can be adapted to account for the new API (e.g., the logical model 132 (e.g., network matrix model) can be updated to include and account for the new API with respect to the services and subscriptions, and/or the trained model 128 can be further trained for outcome recognition, such as recognizing the application entities and/or other information items received from the new API when called).

In some instances, a new entity may be received in the input data, or an order type as a new value. The entity recognition component 108 initially may not be able to recognize such new entity or value. However, the trained model 128 can perform the AI-based analysis on such input data to infer, or at least attempt to infer, what the input data represents (e.g., infer what the new entity or value is). In some embodiments, the trained model can utilize a fuzzy logic-based scoring technique or system as part of the AI-based analysis of such input data to assess or determine the best co-relation (e.g., the highest scoring co-relation) meaning of such input data (e.g., the most probable or likely application entity or value represented by such input data), and can infer the application entity or value represented by the input data, based at least in part on the AI-based analysis results. As part of the feedback loop, the trained model 128 can provide inference information and/or other AI-based analysis results to the user 142 (e.g., via the device 144 or interface) for review and evaluation, such as described herein. The user 142 can provide feedback information (e.g., via the device 144 or interface, and/or via the feedback component 126 of the AI component 122) that can indicate that the inference is correct (e.g., the user 142 can approve the inference), if such inference is correct, or if the trained model 128 was unable to render an inference regarding what the input data is or rendered an incorrect inference regarding what the input data is, the user 142 can provide feedback information that can indicate or specify what such input data represents (e.g., can indicate the application entity or value represented by the input data), and/or the user 142 can configure a new service or subscription type if doing so is desired (e.g., wanted, needed, or called for), given the nature of such input data. For instance, the user 142 can provide the meaning for the new input value (e.g., identify the application entity representation) and the trained model 128 can be further trained (e.g., by the trainer component 124) to recognize the new application entity representation. As another example, if the input data involves a change with regard to service or subscription type, the user 142 can add an entry in the CNF file for the new service or subscription type associated with the input data. As still another example, if the input data involves a change with regard to sequence of API calls, the user 142 can add or modify an entry in the logical model 132 (e.g., network matrix model) to facilitate modifying or updating the sequence of API calls, in accordance with the input data. As yet another example, if the input data relates to a change with regard to an API response, the user 142 can provide a desired (e.g., suitable, acceptable, or accurate) meaning of the API response, and the new entities (e.g., new application entities) that are to be captured by the API when called, in accordance with the input data.

This process for handling a new entity or value typically can take a relatively short amount of time (e.g., ten minutes or less), assuming that the external APIs can be available for the data enrichment process, as compared to existing techniques for workflow development, which may take months to complete. Thus, the disclosed systems, techniques, and processes can act and operate autonomously in virtually all instances (e.g., approximately 90% of the time) to absorb and account for changes, such as referenced herein, and sometimes may involve manual configurations, such as, for example, if an external API(s) has to be developed to account for the change. Further, since, with regard to the disclosed systems, techniques, and processes, most of the operations (e.g., approximately 80% of the operations), except for API calls, can be performed using the models (e.g., trained model 128, logical model 130, and logical model 132) disclosed herein, the total process for processing a request for a service, product, or subscription can be desirably fast, and significantly faster than existing techniques for processing such requests, and even can desirably accommodate large processing in synchronous API calls.

With further regard to the system 100, the DRPM component 102 can comprise or be associated with (e.g., communicatively connected to) a processor component 148 and the data store 146. The processor component 148 can employ one or more processors (e.g., one or more central processing units (CPUs)), accelerators, graphics processing units (GPUs), application-specific integrated circuits (ASICs), microprocessors, or controllers that can process information relating to data, files, services, applications, requests, services, products, subscriptions, devices, users, application entities, entity values, entity recognition, service or subscription types, service or subscription model types, service or subscription models, data enrichment, resources, AI/ML-based models, AI-related data, training data, feedback information, inferences, logical models, threshold (e.g., maximum, minimum, or other threshold) values, weight values, data processing operations, messages, notifications, alarms, alerts, preferences (e.g., user or client preferences), hash values, metadata, parameters, hyperparameters, traffic flows, tables, mappings, policies, defined data processing management criteria, algorithms (e.g., enhanced entity recognition algorithms, enhanced service or subscription type resolver algorithms, enhanced data enrichment determination algorithms, hash algorithms, data compression algorithms, data decompression algorithms, and/or other algorithm), interfaces, APIs, protocols, tools, and/or other information, to facilitate operation of the DRPM component 102 and the system 100, and control data flow between the DRPM component 102 and/or other components (e.g., a device (e.g., 104, 106, or 144), a node, an application, a service, a user, the communication network, network equipment or components, or other entity) associated with the DRPM component 102 and the system 100.

The data store 146 can store data structures (e.g., user data, metadata), code structure(s) (e.g., modules, objects, hashes, classes, procedures) or instructions, information relating to data, files, services, applications, requests, services, products, subscriptions, devices, users, application entities, entity values, entity recognition, service or subscription types, service or subscription model types, service or subscription models, data enrichment, resources, AI/ML-based models, AI-related data, training data, feedback information, inferences, logical models, threshold (e.g., maximum, minimum, or other threshold) values, weight values, data processing operations, messages, notifications, alarms, alerts, preferences (e.g., user or client preferences), hash values, metadata, parameters, hyperparameters, traffic flows, tables, mappings, policies, defined data processing management criteria, algorithms (e.g., enhanced entity recognition algorithms, enhanced service or subscription type resolver algorithms, enhanced data enrichment determination algorithms, hash algorithms, data compression algorithms, data decompression algorithms, and/or other algorithm), interfaces, APIs, protocols, tools, and/or other information, to facilitate controlling or performing operations associated with the DRPM component 102 and the system 100. The data store 146 can comprise volatile and/or non-volatile memory, such as described herein. In an aspect, the processor component 148 can be functionally coupled (e.g., through a memory bus) to the data store 146 in order to store and retrieve information desired to operate and/or confer functionality, at least in part, to the entity recognition component 108, the resolver component 110, the data enricher determination component 112, the data enricher component 114, the model entity recognition component 116, the interface component 118, the model creator component 120, the AI component 122, the processor component 148, the data store 146, and/or other component of the DRPM component 102, and/or substantially any other operational aspects of the DRPM component 102 and the system 100.

As disclosed, the data store 146 can comprise volatile memory and/or nonvolatile memory. By way of example and not limitation, nonvolatile memory can include read only memory (ROM), programmable ROM (PROM), electrically programmable ROM (EPROM), electrically erasable ROM (EEPROM), flash memory, non-volatile memory express (NVMe), NVMe over fabric (NVMe-oF), persistent memory (PMEM), or PMEM-oF. Volatile memory can include random access memory (RAM), which can act as external cache memory. By way of example and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Memory of the disclosed aspects are intended to comprise, without being limited to, these and other suitable types of memory.

With further regard to the AI component 122, the AI component 122 that can perform (e.g., can employ the trained model 128 to perform) AI-based analysis on data and generate AI-based analysis results, in accordance with various aspects and embodiments of the disclosed subject matter.

The AI component 122 can comprise or be associated with the trainer component 124, the feedback component 126, and the model(s) 128. The AI component 122 and/or the trained model 128 can perform an AI-based analysis on data, such as information relating to electronic documents, requests for services, subscriptions, or products, application entities, entity values, document schemas, and/or other types of data, rules (e.g., rules relating to document schemas, application entities and acceptable versions thereof, and/or entity values) and/or feedback information (e.g., feedback information from the user 142, the device 144, or another data source). In some embodiments, with regard to the trained model 128, the AI component 122 can input such information into the trained model 128 for analysis by the trained model 128 to update (e.g., to further train or refine training of) the trained model 128 or to generate output results (e.g., AI-related data) based at least in part on the analysis of the input information.

In connection with or as part of such an AI-based analysis, the AI component 122 can employ, build (e.g., construct or create), and/or import, AI-based techniques and algorithms, AI models 128 (e.g., untrained or trained models), neural networks (e.g., untrained or trained neural networks), decision trees, Markov chains (e.g., trained Markov chains), and/or graph mining to render and/or generate predictions, inferences, calculations, prognostications, estimates, derivations, forecasts, detections, and/or computations that can facilitate determining or learning data patterns in data, determining or learning a correlation, relationship, or causation between an item(s) of data and another item(s) of data (e.g., occurrence of the other item(s) of data or an event relating thereto), determining or learning a correlation, relationship, or causation between an event and another event (e.g., occurrence of another event), determining or recognizing an application entity and/or entity values (e.g., from items of information contained in an electronic document; and/or from items of information received in API responses from APIs), performing other desired functions or operations, and/or automating one or more functions or features of the disclosed subject matter, as more fully described herein.

The AI component 122 and the trained model 128 can employ various AI-based schemes for carrying out various embodiments/examples disclosed herein. In order to provide for or aid in the numerous determinations (e.g., determine, ascertain, infer, calculate, predict, prognose, estimate, derive, forecast, detect, compute) described herein with regard to the disclosed subject matter, the AI component 122 and/or the trained model 128 can examine the entirety or a subset of the data (e.g., the training data; the feedback information; operational data; and/or other information, such as described herein) to which it is granted access and can provide for reasoning about or determine states of the system and/or environment from a set of observations as captured via events and/or data. Determinations can be employed to identify a specific context or action, or can generate a probability distribution over states, for example. The determinations can be probabilistic; that is, the computation of a probability distribution over states of interest based on a consideration of data and events. Determinations can also refer to techniques employed for composing higher-level events from a set of events and/or data.

In certain embodiments, the AI component 122 and/or the trained model(s) 128 can utilize a fuzzy logic-based scoring technique or system as part of the AI-based analysis of one or more items of information (e.g., items of information contained in an electronic document as part of a service, product, or subscription request) to assess or determine the best co-relation (e.g., the highest scoring co-relation) meaning of an item of information (e.g., the most probable or likely application entity or value represented by such item of information), and can infer the application entity or entity value represented by the item of information, based at least in part on the AI-based analysis results. In other embodiments, additionally or alternatively, the AI component 122 and/or the trained model 128 can perform a different type of AI-based analysis on the items of information to facilitate rendering an inference regarding what application entity (ies) an item(s) of information represents and/or what entity value(s) an item(s) of information represents.

In some embodiments, alternatively or additionally, with regard to probabilities, the AI component 122 and/or the trained model(s) 128 can employ one or more threshold probabilities (e.g., threshold probability values) to facilitate making an inference or determination. For instance, in making an inference or a determination regarding whether an item of information (e.g., item of information of respective items of information contained in an electronic document) can be representative of an application entity of the group of application entities (e.g., associated with an application, a document schema, and/or a received request), as part of the AI-based analysis of information, the AI component 122 and/or the trained model(s) 128 can determine a probability that the item of information can be representative of the application entity, and can determine whether the probability (e.g., probability value) satisfies (e.g., meets or exceeds; or is at or greater than) a defined and applicable threshold probability. The AI component 122 and/or the trained model(s) 128 can render (e.g., make or generate) an inference or determination regarding whether the item of information can be representative of the application entity based at least in part on the results of analyzing (e.g., comparing) the probability to the defined and applicable threshold probability (e.g., threshold minimum probability value). As a non-limiting example, the AI component 122 and/or the trained model(s) 128 can render an inference or determination that the item of information can be representative of the application entity based at least in part on determining that the probability satisfies the defined threshold probability (e.g., the probability is the highest probability, relative to other probabilities associated with other application entities that the item of information potentially can represent, and the probability satisfies the defined and applicable threshold probability). In other embodiments, the AI component 122 and/or the trained model(s) 128 can render an inference or determination that the item of information can be representative of the application entity based at least in part on determining that the probability is the highest probability, relative to other probabilities associated with other application entities that the item of information potentially can represent, without regard to (e.g., without applying) any threshold probability.

Such determinations can result in the construction of new events or actions from a set of observed events and/or stored event data, whether or not the events are correlated in close temporal proximity, and whether the events and data come from one or several event and data sources. Components disclosed herein can employ various classification (explicitly trained (e.g., via training data) as well as implicitly trained (e.g., via observing behavior, preferences, historical information, receiving extrinsic information, and so on)) schemes and/or systems (e.g., support vector machines, neural networks, expert systems, Bayesian belief networks, fuzzy logic, data fusion engines, and so on) in connection with performing automatic and/or determined action in connection with the claimed subject matter. Thus, classification schemes and/or systems can be used to automatically learn and perform a number of functions, actions, and/or determinations.

In some embodiments, the AI component 122 and/or the trained model 128 can employ a classifier that can perform an AI-based analysis on data. A classifier can map an input attribute vector, z=(z1, z2, z3, z4, . . . , zn), to a confidence that the input belongs to a class, as by f(2)=confidence (class). Such classification can employ a probabilistic and/or statistical-based analysis (e.g., factoring into the analysis utilities and costs) to determinate an action to be automatically performed. A support vector machine (SVM) can be an example of a classifier that can be employed. The SVM operates by finding a hyper-surface in the space of possible inputs, where the hyper-surface attempts to split the triggering criteria from the non-triggering events. Intuitively, this makes the classification correct for testing data that is near, but not identical to training data. Other directed and undirected model classification approaches include, e.g., naïve Bayes, Bayesian networks, decision trees, neural networks, fuzzy logic models, and/or probabilistic classification models providing different patterns of independence, any of which can be employed. Classification as used herein also is inclusive of statistical regression that is utilized to develop models of priority.

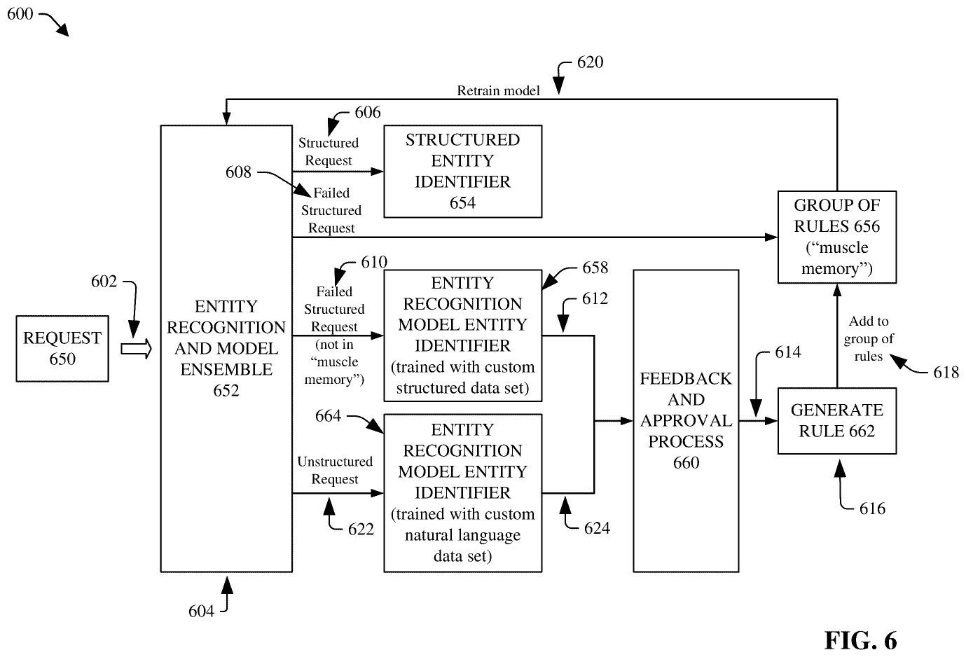

Referring to FIG. 6 (along with FIGS. 1 and 2), FIG. 6 illustrates a block diagram of a non-limiting example process flow 600 that can desirably (e.g., autonomously, automatically, dynamically, suitably, reliably, efficiently, enhancedly, and/or optimally) manage and perform data resolution and data processing, including entity recognition, to facilitate processing of requests for services, subscriptions, or products, in accordance with various aspects and embodiments of the disclosed subject matter. As part of the process flow 600, the DRPM component 102 can receive a request 650 (e.g., a request for a service, product, or subscription) from a device (e.g., 104), as indicated at reference numeral 602 of the process flow 600. The request can be contained in an electronic document that can comprise respective items of information relating to the request.

As indicated at reference numeral 604 of the process flow 600, the entity recognition component 108 can employ an entity recognition and/or model ensemble 652 (e.g., comprising the trained model 128) that can analyze the electronic document, comprising the respective items of information, associated with the request, and can determine, identify, or recognize, or at least attempt to determine, identify, or recognize, the respective application entities and associated respective entity values from the respective items of information contained in the electronic document, such as described herein. The entity recognition and/or model ensemble 652 can comprise an AI/ML flow (e.g., using the trained model 128) that can be employed, if and as desired (e.g., if wanted or needed), to facilitate inferring, determining, or recognizing one or more of the respective application entities and/or one or more of the associated respective entity values from the respective items of information contained in the electronic document, such as described herein.

The entity recognition component 108, employing the entity recognition and/or model ensemble 652, can analyze the electronic document, comprising the items of information, to facilitate determining whether the information of the electronic document is in a structured form (e.g., in accordance with a document schema) or an unstructured form (e.g., natural language form). For instance, the entity recognition component 108 can load the electronic document into one or more document schema frameworks (e.g., document schema tools or applications) relating to one or more document schemas of the group of document schemas for analysis to determine whether the items of information of the electronic document can satisfy (e.g., can conform to) any of the document schemas of the group of document schemas. If the entity recognition component 108 determines that the items of information of the electronic document can satisfy (e.g., can conform to) a document schema of the group of document schemas, based at least in part on the associated document schema framework being able to successfully process the electronic document instead of returning an error (e.g., error indicating that the electronic document does not conform to such document schema), the entity recognition component 108 can determine that the electronic document, comprising the request, can be a structured request.

As indicated at reference numeral 606 of the process flow 600, if the entity recognition component 108 determines that the electronic document comprises a structured request, the entity recognition component 108 (e.g., utilizing the entity recognition and/or model ensemble 652) can employ a structured entity identifier 654 to identify, determine, or recognize respective application entities and/or associated respective entity values from the respective items of information of the electronic document, based at least in part on the results of analyzing the respective items of information. For instance, the entity recognition component 108 can be or can comprise the structured entity identifier 654 and/or can employ the document schema framework to be the structured entity identifier 654, and the structured entity identifier 654 can identify, determine, or recognize the respective application entities and/or the associated respective entity values from the respective items of information of the electronic document, based at least in part on the analysis results.

As indicated at reference numeral 608 of the process flow 600, if, instead, based at least in part on the analysis results, the entity recognition component 108 determines that the electronic document contains a failed structured request in that only some of items of information of the electronic document can satisfy (e.g., can conform to) the document schema, but one or more application entities have not been identified from the items of information of the electronic document, the entity recognition component 108 can employ a group of rules 656 (e.g., generated rules) that can be utilized by the trained model 128 (e.g., as part of the entity recognition and/or model ensemble 652), which can analyze at least certain items of information of the electronic document and the group of rules to facilitate determining or recognizing, or at least attempting to determine or recognize, the one or more application entities that were not able to be identified by the entity recognition component 108 (e.g., using the document schema framework). With regard to each application entity, the group of rules can indicate or specify respective application entity versions or variations that can be representative of the application entity, such as described herein. As an example, if the entity recognition component 108 and/or document schema framework was able to recognize some of the respective application entities from the respective items of information, but was not able to recognize one of the application entities from the respective items of information, the entity recognition component can employ the trained model 128, which can be trained based at least in part on the group of rules, to determine or recognize, or at least attempt to determine or recognize, the application entity that was not able to be identified by the entity recognition component 108 and/or document schema framework. If the trained model 128 is able to determine or recognize that an item of information of the respective items of information can be representative of the application entity (e.g., the item of information can be an acceptable application entity version that can be representative of the application entity), based at least in part on the group of rules, the entity recognition component 108 can determine that all of the desired application entities (e.g., the initially recognized application entities, and the application entity recognized using the trained model 128 and the group of rules) have been recognized or identified, and the entity recognition component 108 can extract the respective entity values associated with the respective application entities from other items of information of the electronic document, such as described herein.

As indicated at reference numeral 610 of the process flow 600, if, instead, based at least in part on the results of analyzing at least the certain items of information of the electronic document and the group of rules, the trained model 128 is not able to identify an application entity (ies) from the items of information of the electronic document, the trained model 128 can employ an entity recognition model entity identifier 658 (e.g., an AI-based entity recognition model entity identifier) to analyze (e.g., perform an AI-based analysis on) the respective items of information, or a portion thereof, of the electronic document to facilitate inferring or determining whether there is an item(s) of information that can be representative of the application entity (ies). The trained model 128 can be trained (e.g., by the trainer component 124) based at least in part on a custom structured data set that can relate to application entities. Based at least in part on such training and the results of the AI-based analysis, the trained model 128 (e.g., the entity recognition model entity identifier 658 employed by the trained model 128) can infer or identify, or at least can attempt to infer or identify, an item of information of the electronic document that can be, or at least potentially (e.g., probably or likely) can be, an acceptable application entity version or variation that can be representative of the application entity.

If the trained model 128 infers that an item of information of the electronic document can be, or at least potentially can be, an acceptable application entity version or variation that can be representative of the application entity, as indicated at reference numeral 612 of the process flow 600, the trained model 128 can communicate inference information relating to such inference to the user 142 (e.g., via the device 144 or the interface) for review, evaluation, and/or approval as part of a feedback and approval process 660. The user 142 can determine whether the inference that the item of information can be an acceptable application entity version or variation that can be representative of the application entity can be approved (e.g., is correct, accurate, or acceptable), based at least in part on the results of evaluating the inference information and/or other information (e.g., information in the electronic document and/or other information).

As indicated at reference numeral 614 of the process flow 600, if the user 142 determines that the inference is approved, the user 142 (e.g., via the device 144 or interface) can communicate feedback information, which can indicate that the item of information can be an acceptable application entity version or variation that can be representative of the application entity, to the entity recognition component 108, AI component 122 (e.g., trainer component 124), or trained model 128. As indicated at reference numeral 616 of the process flow 600, the entity recognition component 108, AI component 122 (e.g., trainer component 124), or trained model 128 can generate a rule 662, based at least in part on the inference information and/or the feedback information, wherein the rule can indicate that the item of information can be an acceptable application entity version or variation that can be representative of the application entity. As indicated at reference numeral 618 of the process flow 600, the entity recognition component 108, AI component 122, or trained model 128 can add the rule 662 to the group of rules 656 (e.g., can update, adapt, or modify the group of rules 656 to include the rule 662).

In some embodiments, as indicated at reference numeral 620 of the process flow 600 (and as part of the feedback loop and the entity recognition and/or model ensemble 652), the trained model 128 can be retrained (e.g., updated or further trained) such that the trained model 128 can be able to recognize (e.g., with regard to subsequent electronic documents) that the item of information can be an acceptable application entity version or variation that can be representative of the application entity, based at least in part on the rule 662 that now can be part of the group of rules 656.

It is noted that, in certain embodiments, if the user 142 had determined that the inference is not correct, the user 142 may indicate or specify another item of information of the electronic document that can be representative of the application entity, or may indicate that there is no item of information of the electronic document that can be representative of the application entity. With regard to the instance where the user 142 may indicate or specify another item of information of the electronic document that can be representative of the application entity, the feedback information from the user 142 can be utilized by the entity recognition component 108, AI component 122 (e.g., trainer component 124), or trained model 128 to generate a corresponding rule 662 that can indicate or specify that the other item of information can be representative of the application entity. If, instead, with regard to the instance where the user 142 may indicate or specify that there is no item of information of the electronic document that can be representative of the application entity, the entity recognition component 108, AI component 122 (e.g., trainer component 124), or trained model 128 may not generate a new rule and may not retrain the trained model 128, or can retrain the trained model 128 to not infer or recognize (e.g., in the future) that item of information as being representative of the application entity.

As indicated at reference numeral 622 of the process flow 600, if, instead, based at least in part on the initial analysis, the entity recognition component 108 determines that the electronic document comprises an unstructured request, the entity recognition component 108 the trained model 128 can employ an entity recognition model entity identifier 664 (e.g., an AI-based entity recognition model entity identifier) to analyze (e.g., perform an AI-based analysis on) the respective items of information, or a portion thereof, of the electronic document to facilitate inferring or determining respective items of information that can be representative of the respective application entities, or at least determining whether there is an item(s) of information that can be representative of an application entity (ies). The trained model 128 can be trained (e.g., by the trainer component 124) based at least in part on a custom unstructured (e.g., natural language) data set that can relate to application entities. Based at least in part on such training and the results of the AI-based analysis, the trained model 128 (e.g., the entity recognition model entity identifier 664 employed by the trained model 128) can infer or identify, or at least can attempt to infer or identify, respective items of information of the electronic document that can be, or at least potentially (e.g., probably or likely) can be, respective acceptable application entity versions or variations that can be representative of the respective application entities.

As indicated at reference numeral 624 of the process flow 600, if, based at least in part on the results of the AI-based analysis performed by the trained model 128 (e.g., employing the entity recognition model entity identifier 664), the trained model 128 can infer respective items of information of the electronic document that can be representative of the respective application entities, the trained model 128 can communicate inference information relating to the respective inferences relating to the respective application entities to the user 142 (e.g., via the device 144 or the interface) for review, evaluation, and/or approval as part of the feedback and approval process 660. The user 142 can determine whether the respective inferences that the respective items of information can be respective acceptable application entity versions or variations that can be representative of the respective application entities can be approved (e.g., are correct, accurate, or acceptable), based at least in part on the results of evaluating the inference information and/or other information (e.g., information in the electronic document and/or other information).

As indicated at reference numeral 614 of the process flow 600, if the user 142 determines that the respective inferences are approved, the user 142 (e.g., via the device 144 or interface) can communicate feedback information, which can indicate that the respective items of information can be respective acceptable application entity versions or variations that can be representative of the respective application entities, to the entity recognition component 108, AI component 122 (e.g., trainer component 124), or trained model 128. As indicated at reference numeral 616 of the process flow 600, the entity recognition component 108, AI component 122 (e.g., trainer component 124), or trained model 128 can generate respective rules 662, based at least in part on the inference information and/or the feedback information, wherein the respective rules can indicate that the respective items of information can be respective acceptable application entity versions or variations that can be representative of the respective application entities. As indicated at reference numeral 618 of the process flow 600, the entity recognition component 108, AI component 122, or trained model 128 can add the respective rules 662 to the group of rules 656 (e.g., can update, adapt, or modify the group of rules 656 to include the respective rules 662).

In some embodiments, as indicated at reference numeral 620 of the process flow 600 (and as part of the feedback loop and the entity recognition and/or model ensemble 652), the trained model 128 can be retrained (e.g., updated or further trained) such that the trained model 128 can be able to recognize (e.g., with regard to subsequent electronic documents) that the respective items of information can be respective acceptable application entity versions or variations that can be representative of the respective application entities, based at least in part on the respective rules 662 that now can be part of the group of rules 656.

It is noted that, similar to as described herein, in certain embodiments, if the user 142 determined that a particular inference of the respective inferences is not correct, the user 142 may indicate or specify another item of information of the electronic document that can be representative of the application entity, or may indicate that there is no item of information of the electronic document that can be representative of the application entity. With regard to the instance where the user 142 may indicate or specify another item of information of the electronic document that can be representative of the application entity, the feedback information from the user 142 can be utilized by the entity recognition component 108, AI component 122 (e.g., trainer component 124), or trained model 128 to generate a corresponding rule 662 that can indicate or specify that the other item of information can be representative of the application entity. If, instead, with regard to the instance where the user 142 may indicate or specify that there is no item of information of the electronic document that can be representative of the application entity, the entity recognition component 108, AI component 122 (e.g., trainer component 124), or trained model 128 may not generate a new rule and may not retrain the trained model 128, or can retrain the trained model 128 to not infer or recognize (e.g., in the future) that item of information as being representative of the application entity.

It is to be appreciated and understood that one or more components (e.g., the devices, the DRPM component, or other component) of the systems (e.g., the system 100 or other system) or methods described herein can comprise or be associated with various other types of components, such as display screens (e.g., touch screen displays or non-touch screen displays), audio functions (e.g., amplifiers, speakers, or audio interfaces), or other interfaces, to facilitate presentation of information to users, entities, or other components (e.g., other devices or other servers), and/or to perform other desired functions or operations.

The aforementioned systems and/or devices have been described with respect to interaction between several components. It should be appreciated that such systems and components can include those components or sub-components specified therein, some of the specified components or sub-components, and/or additional components. Sub-components could also be implemented as components communicatively coupled to other components rather than included within parent components. Further yet, one or more components and/or sub-components may be combined into a single component providing aggregate functionality. The components may also interact with one or more other components not specifically described herein for the sake of brevity, but known by those of skill in the art.

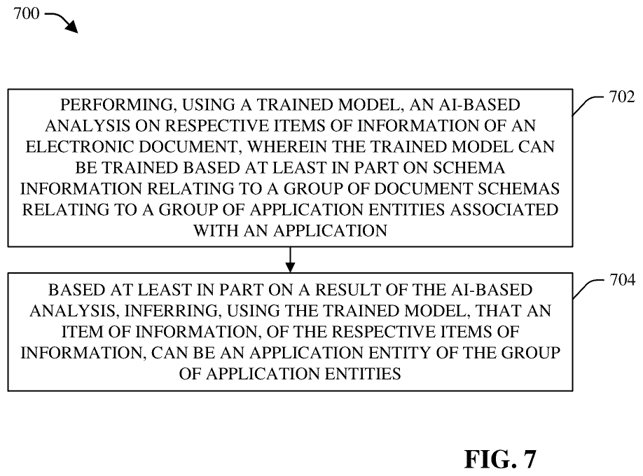

In view of the example systems and/or devices described herein, example methods that can be implemented in accordance with the disclosed subject matter can be further appreciated with reference to flowcharts in FIGS. 7-11. For purposes of simplicity of explanation, example methods disclosed herein are presented and described as a series of acts; however, it is to be understood and appreciated that the disclosed subject matter is not limited by the order of acts, as some acts may occur in different orders and/or concurrently with other acts from that shown and described herein. For example, a method disclosed herein could alternatively be represented as a series of interrelated states or events, such as in a state diagram. Moreover, interaction diagram(s) may represent methods in accordance with the disclosed subject matter when disparate entities enact disparate portions of the methods. Furthermore, not all illustrated acts may be required to implement a method in accordance with the subject specification. It should be further appreciated that the methods disclosed throughout the subject specification are capable of being stored on an article of manufacture to facilitate transporting and transferring such methods to computers for execution by a processor or for storage in a memory.

FIG. 7 illustrates a flow chart of an example method 700 that can desirably (e.g., autonomously, automatically, dynamically, suitably, reliably, efficiently, enhancedly, and/or optimally) infer that an item of information in an electronic document can be an entity (e.g., application or named entity) based at least in part on an AI-based analysis, in accordance with various aspects and embodiments of the disclosed subject matter. The method 700 can be employed by, for example, a system comprising the DRPM component, the processor component, the data store, and/or other components. The DRPM component can comprise the entity recognition component, the trained model, and other components, such as described herein.

At 702, an AI-based analysis can be performed, using a trained model, on respective items of information of an electronic document, wherein the trained model can be trained based at least in part on schema information relating to a group of document schemas relating to a group of application entities associated with an application. The trained model (e.g., trained AI-based model) can perform the AI-based analysis on the respective items of information of the electronic document, such as described herein. The trained model can be trained based at least in part on the schema information relating to the group of document schemas (e.g., JSON schema, XML schema, CSV schema, and/or other type of schema) relating to the group of application entities (e.g., order number, customer identifier, item, item type, item description, quantity, and/or other application or named entity), such as described herein.

At 704, based at least in part on a result of the AI-based analysis, an inference can be made, using the trained model, that an item of information, of the respective items of information, can be an application entity of the group of application entities. Based at least in part on the AI-based analysis results, the trained model can render an inference that the item of information (e.g., ORD_NUM), of the respective items of information contained in the electronic document, can be the application entity (e.g., application or named entity that can be representative of order number) of the group of application entities associated with the application, such as described herein.

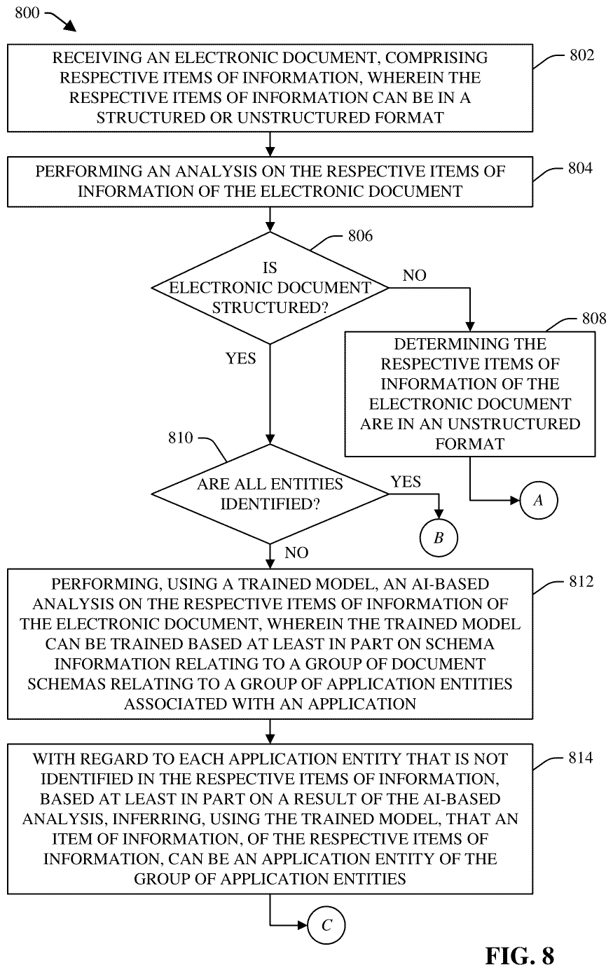

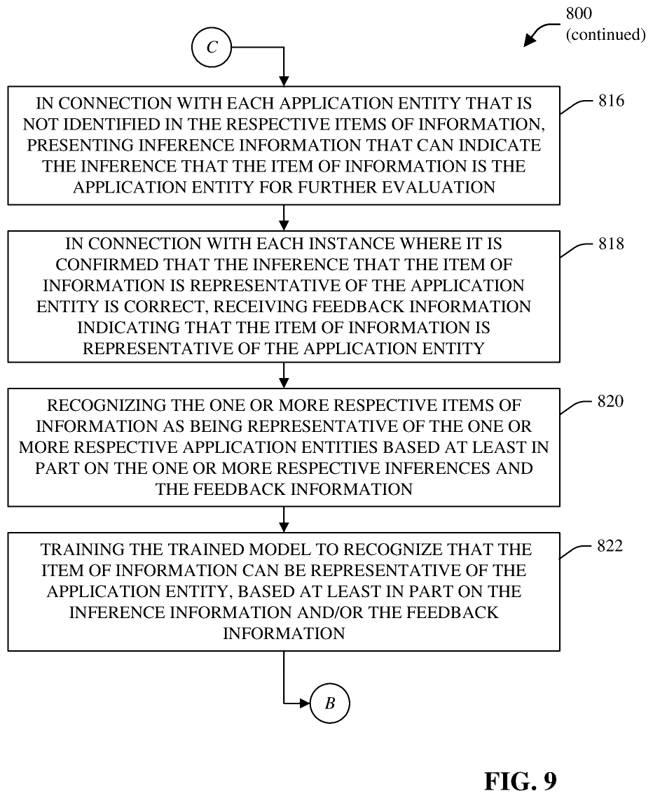

FIGS. 8 and 9 depict a flow chart of an example method 800 that can desirably (e.g., autonomously, automatically, dynamically, suitably, reliably, efficiently, enhancedly, and/or optimally) infer that an item of information in an electronic document can be an entity (e.g., application or named entity), based at least in part on an AI-based analysis, and update training of the trained model to recognize the item of information as being representative of the entity, in accordance with various aspects and embodiments of the disclosed subject matter. The method 800 can be employed by, for example, a system comprising the DRPM component, the processor component, the data store, and/or other components. The DRPM component can comprise the entity recognition component, the trained model, and other components, such as described herein.

At 802, an electronic document, comprising respective items of information, can be received, wherein the respective items of information can be in a structured or unstructured format. The DRPM component can receive the electronic document from a device (e.g., device employing an application that can be used to generate the electronic document). The electronic document can comprise the respective items of information, which can be in the structured format (e.g., JSON format, XML format, CSV format, or other structured format) or unstructured format (e.g., natural language format or other unstructured format).

At 804, an analysis can be performed on the respective items of information of the electronic document. The DRPM component can analyze the respective items of information of the electronic document.

At 806, based at least in part on the analysis results, a determination can be made regarding whether the respective items of information of the electronic document are structured to correspond or at least substantially correspond to a document schema of a group of document schemas. The DRPM component, employing the entity recognition component, can determine whether the respective items of information of the electronic document are structured to correspond or at least substantially correspond to a document schema of the group of document schemas, based at least in part on the analysis results.

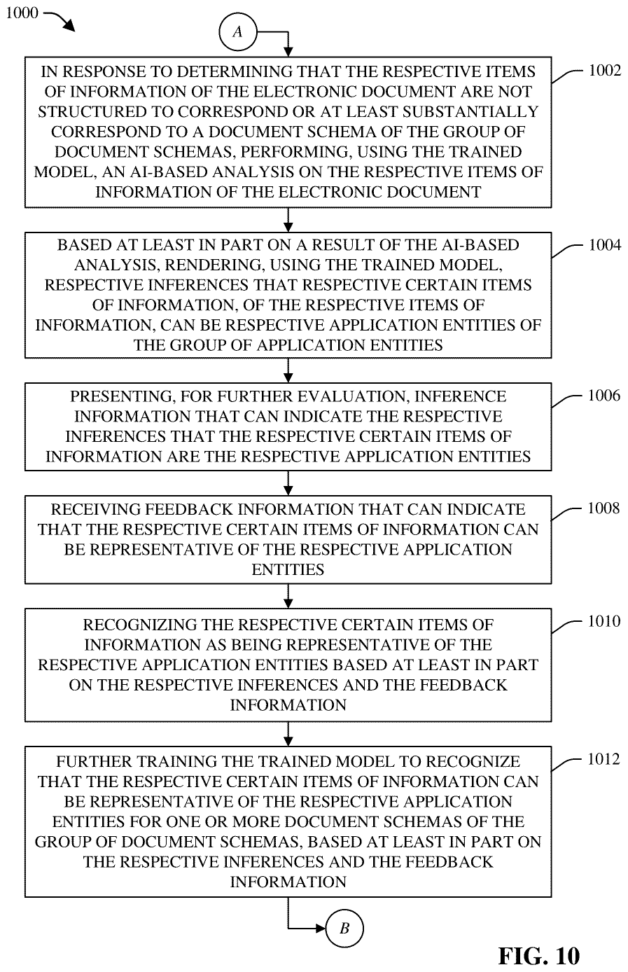

If it is determined that the respective items of information of the electronic document are not structured to correspond or at least substantially correspond to a document schema of the group of document schemas, at 808, a determination can be made that the respective items of information of the electronic document are in an unstructured format. For instance, if, based at least in part on the analysis results, the entity recognition component determines that the respective items of information of the electronic document are not structured to correspond or at least substantially correspond to a document schema of the group of document schemas, the entity recognition component can determine that the respective items of information of the electronic document are in the unstructured format (e.g., natural language format or other unstructured format). At this point, the method 800 can proceed to reference point A, wherein method 1000 can proceed from reference point A to process the electronic document, such as described herein with regard to the method 1000 and shown in FIG. 10.

If, instead, at reference numeral 806, it is determined that the respective items of information of the electronic document are structured to correspond or at least substantially correspond to the document schema of the group of document schemas, at 810, a determination can be made regarding whether respective application entities (e.g., all of the application entities), of a group of application entities, and/or respectively associated entity values are identified in the respective items of information in accordance with the document schema. For instance, if the entity recognition component determines that the respective items of information of the electronic document are structured to correspond or at least substantially correspond to the document schema, the entity recognition component can determine whether the respective application entities, of the group of application entities, and/or respectively associated entity values are identified (e.g., recognized) in the respective items of information in accordance with the document schema. The document schema can define or specify the mapping or structure of the respective application entities of the group of application entities in the electronic document.

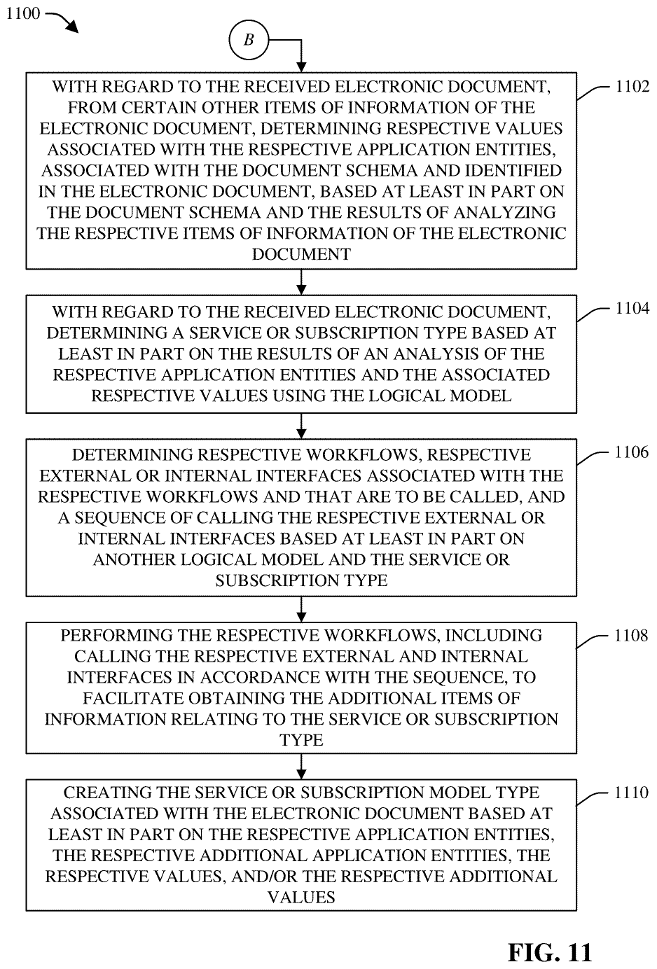

If it is determined that the respective application entities and/or respectively associated entity values are identified in the respective items of information in accordance with the document schema, at this point, the method 800 can proceed to reference point B, wherein method 1100 can proceed from reference point B to facilitate processing of the electronic document and associated request, such as described herein and shown in FIG. 11.

If, instead, at reference numeral 810, it is determined that one or more application entities of the group of application entities, is not identified in the respective items of information based at least in part on the document schema, at 812, an AI-based analysis can be performed, using a trained model, on the respective items of information of the electronic document, wherein the trained model can be trained based at least in part on schema information relating to a group of document schemas relating to a group of application entities associated with an application. The trained model (e.g., trained AI-based model, such as a trained entity recognition model) can perform the AI-based analysis on the respective items of information, such as described herein. The trained model can be trained based at least in part on the schema information relating to the group of document schemas (e.g., JSON schema, XML schema, CSV schema, and/or other type of schema) relating to the group of application entities (e.g., order number, customer identifier, product identifier, item, item type, item description, quantity, and/or other application or named entity), such as described herein.

At 814, with regard to each application entity that is not identified in the respective items of information, based at least in part on a result of the AI-based analysis, an inference can be made, using the trained model, that an item of information, of the respective items of information, can be an application entity of the group of application entities. For instance, with regard to each application entity that is not identified in the respective items of information, based at least in part on the AI-based analysis results, the trained model can render an inference that the item of information (e.g., ProdID), of the respective items of information contained in the electronic document, can be the application entity (e.g., application or named entity that can be representative of the product identifier) of the group of application entities associated with the application, such as described herein.

At this point, the method 800 can proceed to reference point C, wherein the method 800 can proceed (e.g., continue) from reference point C to further process the electronic document, such as described herein with regard to the method 800 and shown in FIG. 9.

At 816, in connection with each application entity that is not identified in the respective items of information, inference information that can indicate the inference that the item of information is the application entity can be presented for further evaluation. For instance, with regard to each application entity that is not identified in the respective items of information, the trained model can present the inference information relating to the inference that the item of information is the application entity for further evaluation. A user (e.g., a technician, an operator, a manager, or other user) can evaluate the inference information to determine whether the inference that the item of information is representative of the application entity is correct. In this example instance, the user can determine or confirm (e.g., verify) that the inference that the item of information is representative of the application entity is correct.

At 818, in connection with each instance where it is confirmed that the inference that the item of information is representative of the application entity is correct, feedback information indicating that the item of information is representative of the application entity can be received. For instance, the trained model can receive the feedback information from the user (e.g., via a device associated with the user).

At 820, the one or more respective items of information can be recognized as being representative of the one or more respective application entities based at least in part on the one or more respective inferences and the feedback information. The entity recognition component and/or the trained model can recognize the one or more respective items of information as being representative of the one or more respective application entities based at least in part on the one or more respective inferences and the feedback information.

At 822, the trained model can be further trained to recognize that the item of information can be representative of the application entity, based at least in part on the inference information and/or the feedback information. For instance, the inference information and/or the feedback information, and/or rule information relating to a rule generated based at least in part on the inference information and/or the feedback information, can be input or applied to the trained model, and the trained model can be updated (e.g., can be further trained, can be refined) to recognize that the item of information can be representative of the application entity, based at least in part on the inference information, the feedback information, and/or the rule information. That is, the trained model can update the mapping relating to the application entities, including the application entity, to include the item of information (e.g., ProdID) as being representative of the application entity (e.g., in addition to other information item versions (e.g., Product_ID and Prod_ID) that can be representative of the application entity, in accordance with the mapping). The mapping(s) can be updated with regard to the document schema and/or one or more of the other document schemas of the group of document schemas (e.g., JSON, XML, CSV, and/or another document schema). As a result, if, in a subsequent electronic document, the trained model encounters the item of information in such subsequent electronic document, the trained model can determine that the item of information can be representative of the application entity based at least in part on the updated mapping (e.g., without having to perform an AI-based analysis and generating an inference that the item of information can be representative of the application entity).

If, instead, with regard to a particular inference, the user determines that the inference that a particular item of information in the electronic document is a particular application entity is not correct, the feedback information can indicate that the particular item of information in the electronic document is not representative of the particular application entity. Accordingly, the updating of the trained model can comprise not including the particular item of information as being representative of the particular application entity, or can comprise updating the trained model to have the trained model recognize that the particular item of information is not representative of the particular application entity.

At this point, the method 800 can proceed to reference point B, wherein the method 1100 can proceed from reference point B to facilitate further processing of the electronic document and associated request, such as described herein and shown in FIG. 11.

FIG. 10 depicts a flow chart of an example method 1000 that can desirably (e.g., autonomously, automatically, dynamically, suitably, reliably, efficiently, enhancedly, and/or optimally) infer that respective items of information in an electronic document, comprising unstructured information, can be respective entities (e.g., respective application or named entities), based at least in part on an AI-based analysis, and update training of the trained model to recognize the respective items of information as being representative of the respective entities, in accordance with various aspects and embodiments of the disclosed subject matter. The method 1000 can be employed by, for example, a system comprising the DRPM component, the processor component, the data store, and/or other components. The DRPM component can comprise the entity recognition component, the trained model, and other components, such as described herein. In accordance with various embodiments, the method 1000 can proceed from reference point A.

At 1002, in response to determining that the respective items of information of the electronic document are not structured to correspond or at least substantially correspond to a document schema of the group of document schemas, an AI-based analysis can be performed, using the trained model, on the respective items of information of the electronic document. The trained model (e.g., trained AI-based model, such as a trained entity recognition model) can perform the AI-based analysis on the respective items of information, such as described herein.

At 1004, based at least in part on a result of the AI-based analysis, respective inferences can be rendered (e.g., made or generated), using the trained model, that respective certain items of information, of the respective items of information, can be respective application entities of the group of application entities. For instance, based at least in part on the AI-based analysis results, the trained model can render the respective inferences that the respective certain items of information, of the respective items of information contained in the electronic document, can be the respective application entities of the group of application entities associated with the application, such as described herein.

At 1006, inference information that can indicate the respective inferences that the respective certain items of information are the respective application entities can be presented for further evaluation. For instance, the trained model can present the inference information relating to the respective inferences for further evaluation. The user (e.g., technician, operator, manager, or other user) can evaluate the inference information to determine whether the respective inferences that the respective certain items of information are representative of the respective application entities are correct. In this example instance, the user can determine that the respective inferences that the respective certain items of information are representative of the respective application entities can be correct.

At 1008, feedback information can be received, wherein the feedback information can indicate that the respective certain items of information can be representative of the respective application entities. For instance, the trained model can receive the feedback information from the user (e.g., via the device associated with the user).

At 1010, the respective certain items of information can be recognized as being representative of the respective application entities based at least in part on the respective inferences and the feedback information. The entity recognition component and/or the trained model can recognize the respective certain items of information as being representative of the respective application entities based at least in part on the respective inferences and the feedback information.

At 1012, the trained model can be further trained to recognize that the respective certain items of information can be representative of the respective application entities for one or more document schemas of the group of document schemas, based at least in part on the respective inferences and the feedback information. For instance, the feedback information can be input or applied to the trained model, and, based at least in part on the feedback information, the trained model can be updated (e.g., can be further trained, can be refined) to recognize that the respective certain items of information can be representative of the respective application entities associated with the application for all or some of the document schemas of the group of document schemas. For example, the trained model can update the mapping relating to the respective application entities to include the respective certain items of information as being representative of the respective application entities for all or some of the document schemas of the group of document schemas. In some embodiments, the trained model can update one or more respective mappings, associated with one or more respective document schemas, to include the respective certain items of information as being representative of the respective application entities to facilitate (e.g., to enable) recognition (e.g., by the entity recognition component and/or the trained model) of the respective certain items of information (e.g., respective same or matching versions of the respective certain items of information) as being representative of the respective application entities with respect to the one or more respective document schemas. As a result, if, in a subsequent electronic document, the trained model encounters any of these items of information in such subsequent electronic document, with regard to each of these items of information, the trained model can determine that such item of information can be representative of the corresponding application entity based at least in part on the updated mapping (e.g., without having to perform an AI-based analysis and generating an inference that the item of information can be representative of the corresponding application entity).

If, instead, with regard to a particular inference, the user determines that the inference that a particular item of information in the electronic document is a particular application entity is not correct, the feedback information can indicate that the particular item of information in the electronic document is not representative of the particular application entity. Accordingly, the updating of the trained model can comprise not including the particular item of information as being representative of the particular application entity, or can comprise updating the trained model to have the trained model recognize that the particular item of information is not representative of the particular application entity.

At this point, the method 1000 can proceed to reference point B, wherein the method 1100 can proceed from reference point B to facilitate further processing of the electronic document and associated request, such as described herein and shown in FIG. 11.

FIG. 11 depicts a flow chart of an example method 1100 that can desirably (e.g., autonomously, automatically, dynamically, suitably, reliably, efficiently, enhancedly, and/or optimally) perform data resolution, data enrichment, and other data processing, to facilitate creating a service or subscription model (e.g., a service or subscription model type) based at least in part on respective application entities (e.g., respective application or named entities) and respective entity values that can be recognized or inferred from information contained in an electronic document associated with a request for a service, product, or subscription, and/or information obtained via interfaces (e.g., APIs), in accordance with various aspects and embodiments of the disclosed subject matter. The method 1100 can be employed by, for example, a system comprising the DRPM component, the processor component, the data store, and/or other components. In accordance with various embodiments, the method 1100 can proceed from reference point B (e.g., where the application entities have been determined and/or extracted in or from the received electronic document).

At 1102, with regard to the received electronic document, from certain other items of information of the electronic document, respective values associated with the respective application entities, associated with the document schema and identified in the electronic document, can be determined, based at least in part on the document schema and the results of analyzing the respective items of information of the electronic document. For instance, based at least in part on the document schema and the analysis results, the entity recognition component can identify or determine (e.g., recognize) respective certain items of information in the electronic document that can be representative of the respective values (e.g., respective entity values) associated with the respective application entities, such as described herein.

At 1104, with regard to the received electronic document, a service or subscription type can be determined based at least in part on the results of an analysis of the respective application entities and the associated respective values using the logical model. For instance, the DRPM component, employing the logical model (e.g., logical model usable to determine the service or subscription type), can analyze the respective application entities and the associated respective values (e.g., the logical model can be applied to or can analyze, and/or the respective application entities and the associated respective values can be input to the logical model for analysis), and, based at least in part on the results of such analysis, the logical model can determine or identify the service or subscription type (e.g., the service, subscription, or business model type) associated with (e.g., requested in) the electronic document. The DRPM component can facilitate creating the service, subscription, or business model type determined from such analysis. In some embodiments, the logical model can employ or be based at least in part on an SAT and/or CNF process to facilitate analyzing the respective application entities and the associated respective values and determining the service or subscription type, such as described herein.

At 1106, respective workflows, respective external or internal interfaces associated with the respective workflows and that are to be called, and a sequence of calling the respective external or internal interfaces can be determined based at least in part on another logical model and the service or subscription type. For instance, the DRPM component, employing the data enricher determination component, can determine the respective workflows, the associated respective external or internal interfaces (e.g., APIs or other interfaces) that are to be called to facilitate obtaining additional items of information relating to the service or subscription, and the sequence of calling the respective external or internal interfaces based at least in part on the other logical model (e.g., network matrix model) and the service or subscription type. The respective workflows can be the workflows desired (e.g., wanted or needed) to be performed in connection with the service or subscription type (e.g., in connection with the provisioning or fulfillment of the service or subscription). The respective external or internal interfaces can be the interfaces desired (e.g., wanted or needed) to be called to facilitate obtaining the additional items of information relating to the service or subscription (e.g., the service, subscription, or business model type).

At 1108, the respective workflows can be performed, and the respective external and internal interfaces can be called in accordance with the sequence, to facilitate obtaining the additional items of information relating to the service or subscription type. The DRPM component, employing the data enricher component, can perform, or can initiate or facilitate performing, the respective workflows, and/or can call, or can initiate or facilitate calling, the respective external and internal interfaces can be called in accordance with the sequence in accordance with the sequence, to facilitate obtaining the additional items of information relating to the service or subscription type. The additional items of information can comprise, for example, one or more additional application entities and/or one or more additional values (e.g., additional entity values) associated with the service or subscription type, and can be recognized by the entity recognition component and associated trained model, such as described herein.

At 1110, the service or subscription model type associated with the electronic document can be created based at least in part on the respective application entities, the respective additional application entities, the respective values, and/or the respective additional values. The DRPM component, employing the model creator component, can create (e.g., generate) the service or subscription model type (e.g., the service, subscription, or business model type) associated with the electronic document based at least in part on the respective application entities, the respective additional application entities, the respective values, and/or the respective additional values.

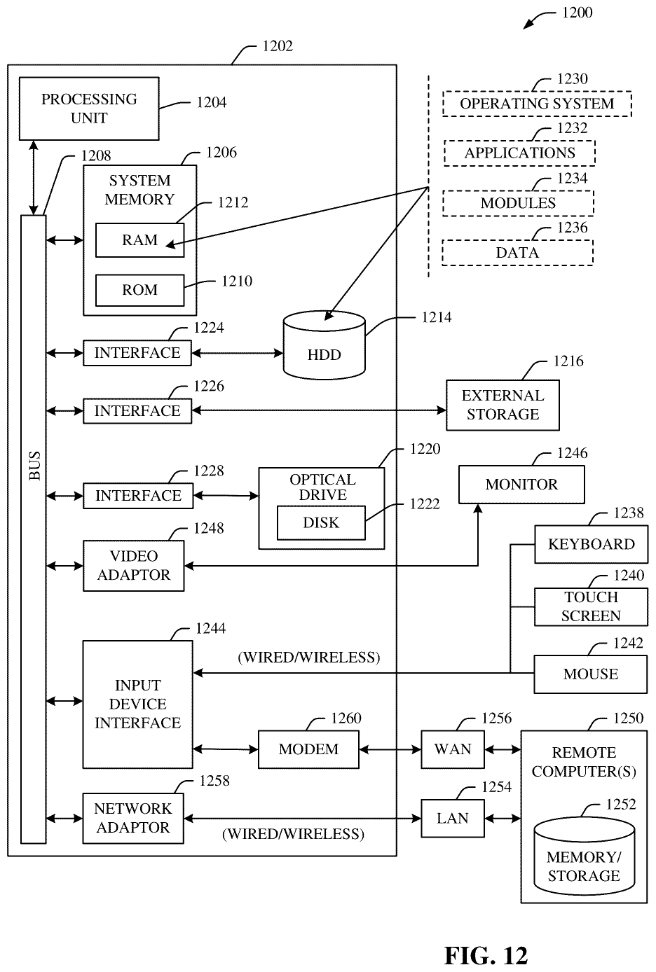

In order to provide additional context for various embodiments described herein, FIG. 12 and the following discussion are intended to provide a brief, general description of a suitable computing environment 1200 in which the various embodiments of the embodiments described herein can be implemented. While the embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the methods can be practiced with other computer system configurations, including single-processor or multiprocessor computer systems, minicomputers, mainframe computers, IoT devices, distributed computing systems, as well as personal computers, hand-held computing devices, microprocessor-based or programmable consumer electronics, and the like, each of which can be operatively coupled to one or more associated devices.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 12, the example environment 1200 for implementing various embodiments of the aspects described herein includes a computer 1202, the computer 1202 including a processing unit 1204, a system memory 1206 and a system bus 1208. The system bus 1208 couples system components including, but not limited to, the system memory 1206 to the processing unit 1204. The processing unit 1204 can be any of various commercially available processors. Dual microprocessors and other multi-processor architectures can also be employed as the processing unit 1204.

The system bus 1208 can be any of several types of bus structure that can further interconnect to a memory bus (with or without a memory controller), a peripheral bus, and a local bus using any of a variety of commercially available bus architectures. The system memory 1206 includes ROM 1210 and RAM 1212. A basic input/output system (BIOS) can be stored in a non-volatile memory such as ROM, erasable programmable read only memory (EPROM), EEPROM, which BIOS contains the basic routines that help to transfer information between elements within the computer 1202, such as during startup. The RAM 1212 can also include a high-speed RAM such as static RAM for caching data.

The computer 1202 further includes an internal hard disk drive (HDD) 1214 (e.g., EIDE, SATA), one or more external storage devices 1216 (e.g., a magnetic floppy disk drive (FDD) 1216, a memory stick or flash drive reader, a memory card reader, etc.) and an optical disk drive 1220 (e.g., which can read or write from a CD-ROM disc, a DVD, a BD, etc.). While the internal HDD 1214 is illustrated as located within the computer 1202, the internal HDD 1214 also can be configured for external use in a suitable chassis (not shown). Additionally, while not shown in environment 1200, a solid state drive (SSD) could be used in addition to, or in place of, an HDD 1214. The HDD 1214, external storage device(s) 1216 and optical disk drive 1220 can be connected to the system bus 1208 by an HDD interface 1224, an external storage interface 1226 and an optical drive interface 1228, respectively. The interface 1224 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 1202, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1212, including an operating system 1230, one or more application programs 1232, other program modules 1234 and program data 1236. All or portions of the operating system, applications, modules, and/or data can also be cached in the RAM 1212. The systems and methods described herein can be implemented utilizing various commercially available operating systems or combinations of operating systems.

Computer 1202 can optionally comprise emulation technologies. For example, a hypervisor (not shown) or other intermediary can emulate a hardware environment for operating system 1230, and the emulated hardware can optionally be different from the hardware illustrated in FIG. 12. In such an embodiment, operating system 1230 can comprise one virtual machine (VM) of multiple VMs hosted at computer 1202. Furthermore, operating system 1230 can provide runtime environments, such as the Java runtime environment or the .NET framework, for applications 1232. Runtime environments are consistent execution environments that allow applications 1232 to run on any operating system that includes the runtime environment. Similarly, operating system 1230 can support containers, and applications 1232 can be in the form of containers, which are lightweight, standalone, executable packages of software that include, e.g., code, runtime, system tools, system libraries and settings for an application.

Further, computer 1202 can be enabled with a security module, such as a trusted processing module (TPM). For instance, with a TPM, boot components hash next in time boot components, and wait for a match of results to secured values, before loading a next boot component. This process can take place at any layer in the code execution stack of computer 1202, e.g., applied at the application execution level or at the operating system (OS) kernel level, thereby enabling security at any level of code execution.

A user can enter commands and information into the computer 1202 through one or more wired/wireless input devices, e.g., a keyboard 1238, a touch screen 1240, and a pointing device, such as a mouse 1242. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1204 through an input device interface 1244 that can be coupled to the system bus 1208, but can be connected by other interfaces, such as a parallel port, an IEEE 1394 serial port, a game port, a USB port, an IR interface, a BLUETOOTH® interface, etc.

A monitor 1246 or other type of display device can be also connected to the system bus 1208 via an interface, such as a video adapter 1248. In addition to the monitor 1246, a computer typically includes other peripheral output devices (not shown), such as speakers, printers, etc.

The computer 1202 can operate in a networked environment using logical connections via wired and/or wireless communications to one or more remote computers, such as a remote computer(s) 1250. The remote computer(s) 1250 can be a workstation, a server computer, a router, a personal computer, portable computer, microprocessor-based entertainment appliance, a peer device or other common network node, and typically includes many or all of the elements described relative to the computer 1202, although, for purposes of brevity, only a memory/storage device 1252 is illustrated. The logical connections depicted include wired/wireless connectivity to a local area network (LAN) 1254 and/or larger networks, e.g., a wide area network (WAN) 1256. Such LAN and WAN networking environments are commonplace in offices and companies, and facilitate enterprise-wide computer networks, such as intranets, all of which can connect to a global communications network, e.g., the Internet.

When used in a LAN networking environment, the computer 1202 can be connected to the local network 1254 through a wired and/or wireless communication network interface or adapter 1258. The adapter 1258 can facilitate wired or wireless communication to the LAN 1254, which can also include a wireless access point (AP) disposed thereon for communicating with the adapter 1258 in a wireless mode.

When used in a WAN networking environment, the computer 1202 can include a modem 1260 or can be connected to a communications server on the WAN 1256 via other means for establishing communications over the WAN 1256, such as by way of the Internet. The modem 1260, which can be internal or external and a wired or wireless device, can be connected to the system bus 1208 via the input device interface 1244. In a networked environment, program modules depicted relative to the computer 1202 or portions thereof, can be stored in the remote memory/storage device 1252. It will be appreciated that the network connections shown are examples and other means of establishing a communications link between the computers can be used.

When used in either a LAN or WAN networking environment, the computer 1202 can access cloud storage systems or other network-based storage systems in addition to, or in place of, external storage devices 1216 as described above. Generally, a connection between the computer 1202 and a cloud storage system can be established over a LAN 1254 or WAN 1256, e.g., by the adapter 1258 or modem 1260, respectively. Upon connecting the computer 1202 to an associated cloud storage system, the external storage interface 1226 can, with the aid of the adapter 1258 and/or modem 1260, manage storage provided by the cloud storage system as it would other types of external storage. For instance, the external storage interface 1226 can be configured to provide access to cloud storage sources as if those sources were physically connected to the computer 1202.

The computer 1202 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

Wi-Fi, or Wireless Fidelity, allows connection to the Internet from a couch at home, in a hotel room, or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, etc.) to provide secure, reliable, fast wireless connectivity. A Wi-Fi network can be used to connect computers to each other, to the Internet, and to wired networks (which use IEEE 802.3 or Ethernet). Wi-Fi networks operate in the unlicensed 2.4 and 5 GHz radio bands, at an 11 Mbps (802.11a) or 54 Mbps (802.11b) data rate, for example, or with products that contain both bands (dual band), so the networks can provide real-world performance similar to the basic 10BaseT wired Ethernet networks used in many offices.

Various aspects or features described herein can be implemented as a method, apparatus, system, or article of manufacture using standard programming or engineering techniques. In addition, various aspects or features disclosed in the subject specification can also be realized through program modules that implement at least one or more of the methods disclosed herein, the program modules being stored in a memory and executed by at least a processor. Other combinations of hardware and software or hardware and firmware can enable or implement aspects described herein, including disclosed method(s). The term “article of manufacture” as used herein is intended to encompass a computer program accessible from any computer-readable device, carrier, or storage media. For example, computer-readable storage media can include but are not limited to magnetic storage devices (e.g., hard disk, floppy disk, magnetic strips, etc.), optical discs (e.g., compact disc (CD), digital versatile disc (DVD), blu-ray disc (BD), etc.), smart cards, and memory devices comprising volatile memory and/or non-volatile memory (e.g., flash memory devices, such as, for example, card, stick, key drive, etc.), or the like. In accordance with various implementations, computer-readable storage media can be non-transitory computer-readable storage media and/or a computer-readable storage device can comprise computer-readable storage media.

As it is employed in the subject specification, the term “processor” can refer to substantially any computing processing unit or device comprising, but not limited to, single-core processors; single-processors with software multithread execution capability; multi-core processors; multi-core processors with software multithread execution capability; multi-core processors with hardware multithread technology; parallel platforms; and parallel platforms with distributed shared memory. A processor can be or can comprise, for example, multiple processors that can include distributed processors or parallel processors in a single machine or multiple machines. Additionally, a processor can comprise or refer to an integrated circuit, an application specific integrated circuit (ASIC), a digital signal processor (DSP), a programmable gate array (PGA), a field programmable gate array (FPGA), a programmable logic controller (PLC), a complex programmable logic device (CPLD), a state machine, a discrete gate or transistor logic, discrete hardware components, or any combination thereof designed to perform the functions described herein. Further, processors can exploit nano-scale architectures such as, but not limited to, molecular and quantum-dot based transistors, switches and gates, in order to optimize space usage or enhance performance of user equipment. A processor may also be implemented as a combination of computing processing units.

A processor can facilitate performing various types of operations, for example, by executing computer-executable instructions. When a processor executes instructions to perform operations, this can include the processor performing (e.g., directly performing) the operations and/or the processor indirectly performing operations, for example, by facilitating (e.g., facilitating operation of), directing, controlling, or cooperating with one or more other devices or components to perform the operations. In some implementations, a memory can store computer-executable instructions, and a processor can be communicatively coupled to the memory, wherein the processor can access or retrieve computer-executable instructions from the memory and can facilitate execution of the computer-executable instructions to perform operations.

In certain implementations, a processor can be or can comprise one or more processors that can be utilized in supporting a virtualized computing environment or virtualized processing environment. The virtualized computing environment may support one or more virtual machines representing computers, servers, or other computing devices. In such virtualized virtual machines, components such as processors and storage devices may be virtualized or logically represented.

In the subject specification, terms such as “store,” “storage,” “data store,” data storage,” “database,” and substantially any other information storage component relevant to operation and functionality of a component are utilized to refer to “memory components,” entities embodied in a “memory,” or components comprising a memory. It is to be appreciated that memory and/or memory components described herein can be either volatile memory or nonvolatile memory, or can include both volatile and nonvolatile memory.

By way of illustration, and not limitation, nonvolatile memory can include read only memory (ROM), programmable ROM (PROM), electrically programmable ROM (EPROM), electrically erasable ROM (EEPROM), or flash memory. Volatile memory can include random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

As used in this application, the terms “component,” “system,” “platform,” “framework,” “layer,” “interface,” “agent,” and the like, can refer to and/or can include a computer-related entity or an entity related to an operational machine with one or more specific functionalities. The entities disclosed herein can be either hardware, a combination of hardware and software, software, or software in execution. For example, a component may be, but is not limited to being, a process running on a processor, a processor, an object, an executable, a thread of execution, computer-executable instructions, a program, and/or a computer. By way of illustration, both an application running on a server and the server can be a component. One or more components may reside within a process and/or thread of execution and a component may be localized on one computer and/or distributed between two or more computers.

In another example, respective components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor. In such a case, the processor can be internal or external to the apparatus and can execute at least a part of the software or firmware application. As yet another example, a component can be an apparatus that provides specific functionality through electronic components without mechanical parts, wherein the electronic components can include a processor or other means to execute software or firmware that confers at least in part the functionality of the electronic components. In an aspect, a component can emulate an electronic component via a virtual machine, e.g., within a cloud computing system.

A communication device, such as described herein, can be or can comprise, for example, a computer, a laptop computer, a server, a phone (e.g., a smart phone), an electronic pad or tablet, an electronic gaming device, electronic headwear or bodywear (e.g., electronic eyeglasses, smart watch, augmented reality (AR)/virtual reality (VR) headset, or other type of electronic headwear or bodywear), a set-top box, an Internet Protocol (IP) television (IPTV), IoT device (e.g., medical device, electronic speaker with voice controller, camera device, security device, tracking device, appliance, or other IoT device), or other desired type of communication device.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form.

As used herein, the terms “example,” “exemplary,” and/or “demonstrative” are utilized to mean serving as an example, instance, or illustration. For the avoidance of doubt, the subject matter disclosed herein is not limited by such examples. In addition, any aspect or design described herein as an “example,” “exemplary,” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, such terms are intended to be inclusive, in a manner similar to the term “comprising” as an open transition word, without precluding any additional or other elements.

It is to be appreciated and understood that components (e.g., DRPM component, device, AI component, trained model, logical model, interface, processor component, data store, or other component), as described with regard to a particular system or method, can include the same or similar functionality as respective components (e.g., respectively named components or similarly named components) as described with regard to other systems or methods disclosed herein.

What has been described above includes examples of systems and methods that provide advantages of the disclosed subject matter. It is, of course, not possible to describe every conceivable combination of components or methods for purposes of describing the disclosed subject matter, but one of ordinary skill in the art may recognize that many further combinations and permutations of the disclosed subject matter are possible. Furthermore, to the extent that the terms “includes,” “has,” “possesses,” and the like are used in the detailed description, claims, appendices and drawings such terms are intended to be inclusive in a manner similar to the term “comprising” as “comprising” is interpreted when employed as a transitional word in a claim.

What is claimed is:

1. A method, comprising:
performing, using a trained model of a system comprising at least one processor, an artificial intelligence-based analysis on respective items of information of an electronic document, wherein the trained model is trained based on schema information relating to a group of document schemas relating to a group of application entities associated with an application; and
based on a result of the artificial intelligence-based analysis, inferring, using the trained model of the system, that an item of information, of the respective items of information, is an application entity of the group of application entities.

2. The method of claim 1, wherein the result if a first result, and wherein the method further comprises:
receiving, by the system, the electronic document;
analyzing, by the system, the respective items of information of the electronic document; and
based on a second result of the analyzing of the respective items of information, determining, by the system, that the item of information contained in the electronic document does not satisfy a defined match criterion with respect to any application entity of the group of application entities associated with any document schema of the group of document schemas, wherein the performing comprises performing the artificial intelligence-based analysis on the respective items of information, in response to determining that the item of information in the electronic document does not satisfy the defined match criterion.

3. The method of claim 1, wherein respective application entities of the group of application entities are arranged within at least some respective electronic documents in accordance with respective formats of respective document schemas of the group of document schemas, and wherein the respective electronic documents comprise the electronic document.

4. The method of claim 1, further comprising:
based on the result of the artificial intelligence-based analysis, determining, using the trained model of the system, respective relationship scores associated with respective application entities of the group of application entities with respect to the item of information, wherein the respective relationship scores indicate respective relationships between the respective application entities and the item of information; and
based on a comparison of the respective relationship scores, determining, using the trained model of the system, that a relationship score associated with the application entity is higher than other relationship scores associated with other of the respective application entities,
wherein the inferring comprises inferring that the item of information is the application entity based on determining that the relationship score associated with the application entity is higher than the other relationship scores associated with the other of the respective application entities.

5. The method of claim 1, further comprising:
based on the inferring, generating, by the system, a recommendation message indicating that the item of information is inferred or recommended to be the application entity;
receiving, by the system, feedback information confirming that the item of information is the application entity; and
determining, by the system, that the item of information is the application entity based on the inferring and the feedback information.

6. The method of claim 5, further comprising:
generating, by the system, a rule indicating that the item of information is an acceptable application entity version indicative or representative of the application entity that is able to be used with respect to at least one document schema of the group of document schemas; and
based on the rule, updating, by the system, training of the trained model to indicate that the item of information is the acceptable application entity version indicative or representative of the application entity that is able to be used with respect to at least the one document schema.

7. The method of claim 1, wherein the item of information is a first item of information, wherein the respective items of information comprise the first item of information and a second item of information, wherein the application entity is a first application entity, wherein the group of application entities comprises the first application entity and a second application entity, and wherein the method further comprises:
based on a result of the artificial intelligence-based analysis, determining, by the system, that the second item of information does not satisfy a defined match criterion with respect to a primary version of the second application entity associated with a document schema of the group of document schemas;
determining, using the trained model of the system, that the second item of information does satisfy the defined match criterion with respect to a secondary version of the second application entity associated with the document schema; and
based on determining that the second item of information does satisfy the defined match criterion with respect to the secondary version of the second application entity associated with the document schema, determining, using the trained model of the system, that the second item of information is the second application entity associated with the document schema.

8. The method of claim 1, wherein the result is a first result, and wherein the method further comprises:
based on a logical model and a second result of analyzing of the respective items of information of the electronic document, determining, by the system, that the respective items of information relate to a service type of a service;
determining, by the system, a group of workflows to be performed based on the service type; and
initiating, by the system, performance of the group of workflows.

9. The method of claim 8, wherein the analyzing of the respective items of information comprises applying the logical model, comprising applying a Boolean satisfiability problem process and a conjunctive normal form, to respective application entities of the group of application entities, respective variables associated with the respective application entities, or the respective items of information, and wherein the method further comprises:
generating, by the system, a conjunctive normal form file based on the second result of the analyzing, comprising the applying of the logical model; and
determining, by the system, the service type of the service based on the conjunctive normal form file.

10. The method of claim 8, wherein the respective items of information are respective first items of information, and wherein the method further comprises:
determining, by the system, respective external or internal interfaces to be called, and a sequence of calling the respective external or internal interfaces, based on the service type and a network matrix, wherein an interface of the respective external or internal interfaces is an application programming interface; and
as part of performance of respective workflows of the group of workflows, initiating, by the system, the calling of the respective external or internal interfaces, based on the sequence, to facilitate obtaining respective second items of information relating to the service.

11. The method of claim 1, further comprising:
initiating, by the system, provisioning of the service based on the respective first items of information of the electronic document, the group of application entities, and the respective second items of information.

12. The method of claim 1, wherein the respective items of information of the electronic document are in a language-independent object notation-based format, an extensible markup language format, a comma-separated-values format, or a natural language format, and
wherein the group of document schemas relate to the language-independent object notation-based format, the extensible markup language format, or the comma-separated-values format.

13. A system, comprising:
at least one memory that stores computer executable components; and
at least one processor that executes computer executable components stored in the at least one memory, wherein the computer executable components comprise:
an entity recognition engine that receives an electronic document; and
a trained model that performs an artificial intelligence-based analysis on the electronic document comprising respective items of data, wherein the trained model is trained based on schema data relating to a group of document schemas relating to a group of named entities associated with an application, and
wherein, based on a result of the artificial intelligence-based analysis, the trained model derives that an item of data, of the respective items of data, is a named entity of the group of named entities.

14. The system of claim 13, wherein the result is a first result, wherein the entity recognition engine analyzes the respective items of data contained in the electronic document, and, based on a second result of the analysis of the respective items of data, the entity recognition engine determines that the item of data does not correspond to any named entity of the group of named entities associated with any document schema of the group of document schemas, and
wherein the trained model performs the artificial intelligence-based analysis on the respective items of data, based on the determination that the item of data in the electronic document does not correspond to any named entity of the group of named entities.

15. The system of claim 13, wherein, based on the result of the artificial intelligence-based analysis, the trained model determines respective probability values associated with respective named entities of the group of named entities with respect to the item of data, wherein the respective probability values indicate respective probabilities between the respective named entities and the item of data,
wherein, based on a comparison of the respective probability values, the trained model determines that a probability value associated with the named entity is higher than other probability values associated with other of the respective named entities, and wherein the trained model derives or infers that the item of data is the named entity based on the determination that the probability value associated with the named entity is higher than the other probability values associated with the other of the respective named entities.

16. The system of claim 13, wherein, based on the derivation that the item of data is the named entity, the entity recognition engine communicates a recommendation message that indicates that the item of data is derived or recommended to be the named entity, and wherein, in response to the recommendation message, the entity recognition engine receives feedback data confirming that the item of data is the named entity, and, based on the derivation and the feedback data determines that the item of data is the named entity.

17. The system of claim 16, wherein the entity recognition engine generates a rule that indicates that the item of data is an acceptable named entity version indicative or representative of the named entity that is able to be used with respect to at least one document schema of the group of document schemas, and
wherein, based on the rule, the entity recognition engine or the trained model updates training of the trained model to indicate that the item of data is the acceptable named entity version indicative or representative of the named entity that is able to be used with respect to at least the one document schema.

18. The system of claim 13, wherein respective items of data are respective first items of data, wherein the result is a first result, and wherein the computer executable components further comprise:
a resolver that determines that the respective items of data relate to a service type of a service or a subscription type of a subscription, based on a logical model and a second result of an analysis of the respective items of data of the electronic document;
a data enricher determination engine that determines a group of workflows to be performed based on the service type or the subscription type, wherein, in connection with the determination of the group of workflows, the data enricher determination engine determines respective external or internal interfaces to be called, and a sequence of calling the respective external or internal interfaces, based on a network matrix and the service type or the subscription type;
a data enricher that initiates performance of the group of workflows and calls of the respective external or internal interfaces in accordance with the sequence, to facilitate obtaining respective second items of data relating to the service or the subscription; and
a model generator that generates a model type relating to the service or the subscription, based on the respective first items of the data of the electronic document, the group of named entities, and the respective second items of data, to facilitate provisioning of the service or the subscription.

19. A non-transitory machine-readable medium, comprising executable instructions that, when executed by at least one processor, facilitate performance of operations, comprising:
executing, using a trained model, an artificial intelligence-based analysis on respective items of data of an electronic document, wherein the trained model is trained based on format data relating to a group of document formats relating to a group of named entities associated with an application; and
based on a result of the artificial intelligence-based analysis, inferring, using the trained model, that an item of data, of the respective items of data, is a named entity of the group of named entities.

20. The non-transitory machine-readable medium of claim 19, wherein the result is a first result, and wherein the operations further comprise:
receiving the electronic document;
analyzing the respective items of data contained in the electronic document;
based on a second result of the analyzing of the respective items of data, determining that the item of data contained in the electronic document does not satisfy a defined match criterion with respect to any named entity of the group of named entities associated with any document format of the group of document formats, wherein the executing comprises executing the artificial intelligence-based analysis on the respective items of data, in response to determining that the item of data in the electronic document does not satisfy the defined match criterion;
based on the inferring, generating a recommendation message indicating that the item of data is the named entity;
receiving feedback data confirming that the item of data is the named entity; and
determining that the item of data is the named entity based on the inferring and the feedback data.
